(19) United States
(12) Patent Application Publication
(10) Pub. No.: US 2023/0382321 A1
(43) Pub. Date: Nov. 30, 2023

(54) COMPOSITE WIRE HARNESS

(71) Applicant: SUMITOMO WIRING SYSTEMS, LTD., Yokkaichi-shi, Mie (JP)

(72) Inventors: Ryuta SAITO, Yokkaichi-shi (JP); Katsutoshi IZAWA, Yokkaichi-shi (JP); Kosuke TANAKA, Yokkaichi-shi (JP)

(73) Assignee: SUMITOMO WIRING SYSTEMS, LTD., Yokkaichi-shi, Mie (JP)

(21) Appl. No.: 18/031,245

(22) PCT Filed: Oct. 13, 2021
(86) PCT No.: PCT/JP2021/037818

§ 371 Date: Apr. 11, 2023

(30) Foreign Application Priority Data
Oct. 22, 2020 (JP) 2020-177195

(51) Int. Cl. B60R 16/02

(52) U.S. Cl. CPC B60R 16/0207

(57) ABSTRACT

A composite wire harness, including: a first wire harness including a first electric wire and a first exterior tube covering the first electric wire; a second wire harness including a second electric wire and a second exterior tube covering the second electric wire; and a first path regulator configured to be attached to the first wire harness and the second wire harness.

### BACKGROUND

The present disclosure relates to a composite wire harness.

JP 2012-197034A discloses a vehicle composite wire harness, for example. This composite wire harness includes a first wire harness formed by passing a first electric wire through a metal pipe and a second wire harness formed by passing a second electric wire through a corrugated tube made of a synthetic resin. In the first wire harness, the metal pipe covers most of the first electric wire in the lengthwise direction thereof, and thus protects the first electric wire from flying objects, water droplets, and the like. Also, the metal pipe regulates the wiring path of the first electric wire. The second wire harness is arranged in parallel with the first wire harness and is linked to the metal pipe. Thus, the metal pipe also regulates the wiring path of the second electric wire of the second wire harness.

### SUMMARY

In the aforementioned wire harness, the first electric wire is protected by the metal pipe used to regulate the path of the first electric wire. Here, it is desirable that the diameter of the metal pipe is the smallest diameter possible in order to achieve a reduction in weight and size. However, reducing the diameter of the metal pipe may lead to cases where a component such as a connector attached to an end portion of the first wire harness in the lengthwise direction cannot be passed through the metal pipe. Thus, before a component such as a connector is attached to an end portion of the first electric wire in the lengthwise direction, the first electric wire needs to be passed through the metal pipe, which leaves room for improvement regarding the assembly workability of the composite wire harness.

An exemplary aspect of the disclosure provides a composite wire harness that makes it possible to improve the assembly workability.

A composite wire harness of the present disclosure includes: a first wire harness including a first electric wire and a first exterior tube covering the first electric wire; a second wire harness including a second electric wire and a second exterior tube covering the second electric wire; and a first path regulator configured to be attached to the first wire harness and the second wire harness, wherein: the first wire harness is arranged side by side with the second wire harness, the first path regulator includes a first main body that partially covers an outer periphery of the first exterior tube and the second exterior tube, and a first insertion port formed by a first end and a second end that are both ends in a circumferential direction of the first main body, the first insertion port is an opening extending in a lengthwise direction of the first path regulator and extends over an entire length of the first path regulator, and the first path regulator collectively holds the first wire harness and the second wire harness.

According to the present disclosure, it is possible to provide a composite wire harness that makes it possible to improve the assembly workability.

### BRIEF DESCRIPTION OF THE DRAWINGS

FIG. 1 is a schematic configuration diagram showing a composite wire harness according to a first embodiment.

FIG. 2 is a plan view of the composite wire harness of the same embodiment.

FIG. 3 is a cross-sectional view taken along line 3-3 in FIG. 2.

FIG. 4 is a plan view of a composite wire harness according to a second embodiment.

FIG. 5 is a cross-sectional view taken along line 5-5 in FIG. 4.

FIG. 6 is a plan view of a composite wire harness according to a third embodiment.

FIG. 7 is a cross-sectional view taken along line 7-7 in FIG. 6.

FIG. 8 is a plan view of a composite wire harness according to a fourth embodiment.

FIG. 9 is a cross-sectional view taken along line 9-9 in FIG. 8.

FIG. 10 is a plan view of a composite wire harness according to a fifth embodiment.

FIG. 11 is a cross-sectional view taken along line 11-11 in FIG. 10.

FIG. 12 is a schematic perspective view of a first path regulating member of the fifth embodiment.

FIG. 13 is a schematic cross-sectional view of a composite wire harness of a modified example.

### DETAILED DESCRIPTION OF EMBODIMENTS

### Description of Embodiments of Disclosure

First, embodiments of the present disclosure are listed and described.

A composite wire harness of the present disclosure is

[1] A composite wire harness, including: a first wire harness including a first electric wire and a first exterior member covering the first electric wire; a second wire harness including a second electric wire and a second exterior member covering the second electric wire; and a first path regulating member configured to be attached to the first wire harness and the second wire harness, in which the first wire harness is arranged side by side with the second wire harness, the first path regulating member includes a first main body portion that partially covers an outer periphery of the first exterior member and the second exterior member, and a first insertion port formed by a first end portion and a second end portion that are both end portions in a circumferential direction of the first main body portion, the first insertion port is an opening extending in a lengthwise direction of the first path regulating member and extends over the entire length of the first path regulating member, and the first path regulating member collectively holds the first wire harness and the second wire harness.

According to this configuration, after performing terminal processing such as attaching a connector to each of the ends in the lengthwise direction of the first electric wire and the second electric wire, the first path regulating member can be attached to the first exterior member and the second exterior member through the first insertion port. Since the first path regulating member can be retrofitted to the first exterior member and the second exterior member in this manner, it is possible to improve the assembly workability of the composite wire harness.

Also, the first path regulating member collectively holds the first exterior member and the second exterior member to regulate the paths of the first wire harness and the second wire harness. That is, since the paths of a plurality of wire harnesses can be regulated by one first path regulating member, it is possible to contribute to a reduction in the number of components of the composite wire harness.

[2] The first path regulating member is harder than the first exterior member and the second exterior member.

According to this configuration, the paths of the first wire harness and the second wire harness can be more strongly regulated by the hard first path regulating member.

[3] The first path regulating member includes a first protruding portion that protrudes from an inner surface of the first end portion and comes into contact with an outer surface of the first exterior member, and a second protruding portion that protrudes from an inner surface of the second end portion and comes into contact with an outer surface of the second exterior member.

According to this configuration, the first protruding portion and the second protruding portion can prevent the first exterior member and the second exterior member from deviating from the first path regulating member through the first insertion port. As a result, unintended deviation of the first path regulating member is suppressed, and therefore the assembly workability of the composite wire harness can be further improved.

[4] The first path regulating member has a partition portion that protrudes from the first main body portion toward the first insertion port, and the partition portion is located between the first exterior member and the second exterior member.

According to this configuration, in the first path regulating member, the partition portion separates the portion where the first exterior member is arranged and the portion where the second exterior member is arranged from each other. For this reason, it is possible to improve the workability when attaching the first exterior member and the second exterior member to the first path regulating member.

[5] A leading end portion of the partition portion includes a first leading end portion that partially covers the outer periphery of the first exterior member and a second leading end portion that extends in a direction different from that of the first leading end portion and partially covers the outer periphery of the second exterior member.

According to this configuration, the leading end portion of the partition portion is formed to be bifurcated into the first leading end portion and the second leading end portion. This makes it possible to individually set the length of the first leading end portion and the length of the second leading end portion, for example. For this reason, it is possible to individually adjust the range of the outer periphery of the first exterior member covered by the first leading end portion and the range of the outer periphery of the second exterior member covered by the second leading end portion.

[6] The partition portion includes a first protrusion portion that protrudes from an inner surface of the first leading end portion toward the first exterior member, and a second protrusion portion that protrudes from an inner surface of the second leading end portion toward the second exterior member.

According to this configuration, the partition portion has the first protrusion portion that protrudes from the inner surface of the first leading end portion toward the first exterior member. Thus, the first protrusion portion can prevent the first exterior member from deviating from the first path regulating member. Also, the partition has a second protrusion portion that protrudes from the inner surface of the second leading end portion toward the second exterior member. Thus, the second protrusion portion can prevent the second exterior member from deviating from the first path regulating member.

[7] The composite wire harness according to any one of claims 1 to 6, further including a second path regulating member configured to be attached to the outer periphery of the first exterior member, in which the second path regulating member includes a second main body portion that partially covers the outer periphery of the first exterior member, and a second insertion port formed by a third end portion and a fourth end portion that are both end portions in a circumferential direction of the second main body portion, the second insertion port is an opening extending in a lengthwise direction of the second path regulating member and extends over the entire length of the second path regulating member, and the second path regulating member is arranged between the outer peripheral surface of the first exterior member and the first path regulating member.

According to this configuration, since the second path regulating member attached to the first exterior member is provided inside the first path regulating member, the first exterior member can be more preferably protected from flying objects and the like. As a result, it is possible to contribute to improving the durability of the composite wire harness.

Also, the first path regulating member and the second path regulating member can more favorably regulate the paths of the first wire harness and the second wire harness.

Also, since the first exterior member is double-covered by the first path regulating member and the second path regulating member, heat transfer from the outside to the first exterior member can be suppressed more favorably.

Also, the second insertion port of the second path regulating member is an opening that extends in the lengthwise direction of the second path regulating member, and extends over the entire length of the second path regulating member. This makes it possible to attach the second path regulating member to the first exterior member through the second insertion port after performing terminal processing such as attachment of a connector to the end portions in the lengthwise direction of the first electric wire. Since the second path regulating member can be retrofitted to the first exterior member in this manner, it is possible to contribute to improving the assembly workability of the composite wire harness.

[8] The second path regulating member is harder than the first exterior member.

According to this configuration, the route of the first wire harness can be more firmly regulated by the hard second path regulating member.

[9] The second path regulating member is longer than the first path regulating member in the lengthwise direction of the first wire harness.

According to this configuration, for example, when the first wire harness requires path regulation in a section longer than that of the second wire harness, it is possible to regulate only the location requiring path regulation by lengthening the second path regulating member attached to the first exterior member, instead of lengthening the first path regulating member. That is, it is not necessary to expand the first path regulating member to the section where path regulation is not required in the second wire harness, and as a result, it is possible to contribute to reducing the size of the first path regulating member, and consequently, to contribute to reducing the weight of the composite wire harness.

[10] The second path regulating member includes a third protruding portion that protrudes from an inner surface of at least one of the third end portion and the fourth end portion and comes into contact with the outer surface of the first exterior member.

According to this configuration, the third protruding portion can prevent the first exterior member from deviating from the second path regulating member through the second insertion port. As a result, unintended deviation of the second path regulating member is prevented, and therefore the assembly workability of the composite wire harness can be further improved.

[11] The composite wire harness further includes a third path regulating member configured to be attached to the first path regulating member, in which the third path regulating member includes a third main body portion covering an outer periphery of the first path regulating member, and a third insertion port formed by a fifth end portion and a sixth end portion that are both end portions in the circumferential direction of the third main body portion, and the third insertion port is an opening extending in a lengthwise direction of the third path regulating member and extends over the entire length of the third path regulating member.

According to this configuration, since the third path regulating member is provided outside of the first path regulating member, it is possible to more preferably protect the first exterior member and the second exterior member from flying objects and the like. As a result, it is possible to contribute to an improvement in the durability of the composite wire harness.

Also, the paths of the first wire harness and the second wire harness can be more favorably regulated by the first path regulating member and the third path regulating member.

Also, since the first exterior member and the second exterior member are double-covered by the first path regulating member and the third path regulating member, it is possible to more favorably prevent heat transmission from the outside to the first exterior member and the second exterior member.

Also, the third insertion port of the third path regulating member is an opening that extends in the lengthwise direction of the third path regulating member, and extends over the entire length of the third path regulating member. As a result, the third path regulating member can be retrofitted through the third insertion port, and therefore it is possible to contribute to improving the assembly workability of the composite wire harness.

[12] The third path regulating member is harder than the first exterior member and the second exterior member.

According to this configuration, the paths of the first wire harness and the second wire harness can be more firmly regulated by the hard third path regulating member.

[13] The third path regulating member is shorter than the first path regulating member in the lengthwise direction of the first path regulating member.

According to this configuration, it is possible to provide the third path regulating member at only the location where the third path regulating member is required in the composite wire harness. Accordingly, it is not necessary to extend the third path regulating member to a location where the third path regulating member is not required, and as a result, it is possible to contribute to reducing the size of the third path regulating member, and consequently, to contribute to reducing the weight of the composite wire harness.

[14] The third path regulating member is made of a metal material.

According to this configuration, it is possible to effectively block heat transmitted from the outside to the first exterior member and the second exterior member by the third path regulating member made of a metal material.

[15] The first path regulating member is made of a synthetic resin material.

According to this configuration, the first path regulating member provided between the first and second exterior members and the third path regulating member is made of a synthetic resin material. For this reason, the first path regulating member made of synthetic resin can prevent the third path regulating member made of metal from coming into contact with the first exterior member and the second exterior member. As a result, it is possible to suppress wear of the first exterior member and the second exterior member resulting from contact with the third path regulating member made of metal.

[16] The third path regulating member is made of a colored synthetic resin material.

According to this configuration, the third path regulating member can be given a desired color without coating its surface. For example, when at least one of the first electric wire and the second electric wire is a high voltage electric wire, by making the color of the first path regulating member a color that enables the worker to recognize that at least one of the first electric wire and the second electric wire is a high voltage electric wire, it is possible to prompt the worker to be careful not to cut the composite wire harness including the high-voltage electric wire by mistake.

[17] The first path regulating member is made of a colored synthetic resin material, and the third path regulating member is made of a synthetic resin material that is the same color as the first path regulating member.

According to this configuration, it is possible to make the first path regulating member and the third path regulating member a desired color without coating their surfaces. For example, when at least one of the first electric wire and the second electric wire is a high voltage electric wire, by making the color of the first path regulating member a color that enables the worker to recognize that at least one of the first electric wire and the second electric wire is a high-voltage electric wire, it is possible to prompt the worker to be careful not to cut the composite wire harness including the high-voltage electric wire by mistake.

[18] The second path regulating member is made of a colored synthetic resin material.

According to this configuration, the second path regulating member can be given a desired color without coating its surface. For example, when the first electric wire is a high-voltage electric wire, by making the color of the second path regulating member a color that enables the operator to recognize that the first electric wire is a high-voltage electric wire, it is possible to prompt the worker to be careful not to cut the first wire harness including the high-voltage electric wire by mistake.

[19] The first path regulating member is made of a colored synthetic resin material, and the second path regulating member is made of a synthetic resin material that is the same color as the first path regulating member.

According to this configuration, it is possible to make the first path regulating member and the second path regulating member a desired color without coating their surfaces. For example, when the first electric wire is a high-voltage electric wire, by making the color of the first path regulating member and the second path regulating member a color that enables the worker to recognize that the first electric wire is a high-voltage electric wire, it is possible to prompt the worker to be careful not to cut the first wire harness including the high-voltage wire by mistake.

[20] The first path regulating member is made of a colored synthetic resin material.

According to this configuration, the first path regulating member can be given a desired color without coating its surface. For example, when at least one of the first electric wire and the second electric wire is a high-voltage electric wire, by making the color of the first path regulating member a color that enables the worker to recognize that at least one of the first electric wire and the second electric wire is a high-voltage electric wire, it is possible to prompt the worker to be careful not to cut the composite wire harness including the high-voltage electric wire by mistake.

[21] The first path regulating member is made of a metal material.

According to this configuration, it is possible to effectively block heat transmitted from the outside to the first exterior member and the second exterior member by the first path regulating member made of a metal material.

[22] The first exterior member has a larger outer shape than the second exterior member.

According to this configuration, the first path regulating member collectively holds the first exterior member and the second exterior member having different outer sizes, and regulates the paths of the first wire harness and the second wire harness. That is, even if the first exterior member and the second exterior member have different outer sizes, it is possible to restrict the paths of a plurality of wire harnesses with use of one first path regulating member. This can contribute to a reduction in the number of components of the composite wire harness.

[23] The first wire harness has two of the first electric wires, the second wire harness has three of the second electric wires, the two first electric wires are electric wires that form a direct-current circuit, and the three second electric wires are electric wires that form a three-phase circuit.

According to this configuration, the path between the first wire harness having the two first electric wires forming the direct-current circuit and the second wire harness having the three second electric wires forming the three-phase circuit can be regulated by one first path regulating member. As a result, one first path regulating member can regulate the paths of the first wire harness and the second wire harness used in, for example, a four-wheel-drive vehicle. For this reason, it is possible to contribute to a reduction in the number of components of the composite wire harness.

### DESCRIPTION OF EMBODIMENTS OF DISCLOSURE

Specific examples of a composite wire harness according to the present disclosure will be described below with reference to the drawings. Parts of structures may be exaggerated or simplified in the drawings for ease of description. Also, dimensional proportions of parts may differ between drawings. The terms “parallel” and “orthogonal” as used in the present specification do not only include being exactly parallel and orthogonal but also include being substantially parallel and orthogonal within a range in which the functions and effects according to the embodiment are achieved.

Note that “tubular” used in the description of the present specification does not only include a tubular shape formed by a peripheral wall that is continuous over the entirety of the circumferential direction thereof but also includes tubular shapes formed by combining two or more components and tubular shapes from which a portion thereof is missing in the circumferential direction, such as a C-shape. Also, a tubular shape includes circular shapes, oval shapes, and polygonal shapes that have pointed or round corners. Also, the term “annular” used in the description of the present specification refers to any structure that forms a loop or an ordinary loop-shaped structure that has a continuous shape without an end portion and a structure that has a gap, such as a C-shaped structure. Note that an annular shape includes a circular shape, an oval shape, and a polygonal shape that has pointed or rounded corners, but there is no limitation thereto.

### First Embodiment

Hereinafter, a first embodiment of a composite wire harness will be described.

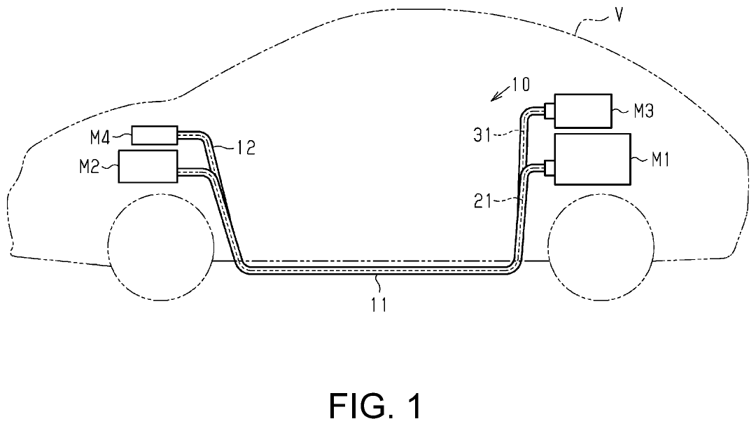

A composite wire harness 10 shown in FIG. 1 is, for example, a wire harness that connects devices provided in a vehicle V to each other. The composite wire harness 10 is arranged in the vehicle V such that an intermediate portion of the composite wire harness 10 in the lengthwise direction thereof extends outside the vehicle interior, such as under the floor of the vehicle V.

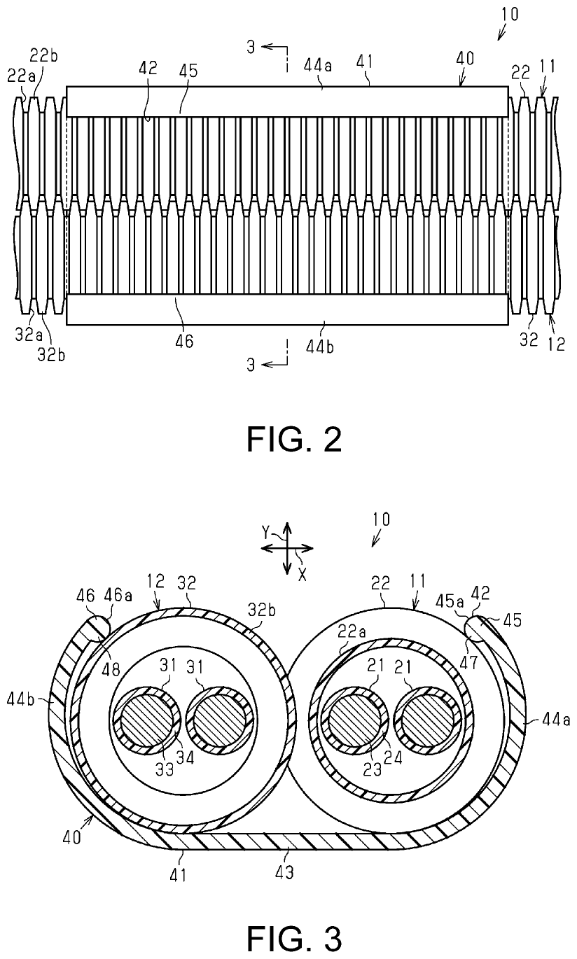

The composite wire harness 10 includes a first wire harness 11 and a second wire harness 12 arranged side by side. The first wire harness 11 and the second wire harness 12 are arranged parallel to each other, for example. Also, the composite wire harness 10 includes a first path regulating member 40 (first path regulator) shown in FIG. 2. The first path regulating member 40 collectively holds the first wire harness 11 and the second wire harness 12. Note that in FIG. 1, illustration of the first path regulating member 40 is omitted.

As shown in FIG. 1, the first wire harness 11 electrically connects a first device M1 and a second device M2 provided in the vehicle V to each other. As examples of the first device M1 and the second device M2, the first device M1 is a high-voltage battery disposed toward the rear side of the vehicle V, and the second device M2 is an inverter disposed toward the front side of the vehicle V. The first device M1, which is a high-voltage battery, is a battery that can supply a voltage of 100 or more volts, for example. The second device M2, which is an inverter, is connected to a wheel driving motor (not shown) that serves as a motive power source for travel by the vehicle. The inverter generates AC power from DC power from the high-voltage battery and supplies the resulting AC power to the motor. The first wire harness 11 is a high-voltage wire harness that allows the passage of high voltages between the high-voltage battery and the inverter.

The second wire harness 12 electrically connects a third device M3 and a fourth device M4 provided in the vehicle V to each other. As examples of the third device M3 and the fourth device M4, the third device M3 is a low-voltage battery that is disposed toward the rear side of the vehicle V, and the fourth device M4 is a relay box disposed toward the front side of the vehicle V. The fourth device M4, which is a relay box, distributes the voltage of the low-voltage battery to various devices installed in the vehicle V. The second wire harness 12 is a low-voltage wire harness that can support currents supplied from the low-voltage battery. Note that the first wire harness 11 and the second wire harness 12 are formed so as to be bent two- or three-dimensionally so as to match a wiring path.

### Configuration of First Wire Harness 11

As shown in FIG. 3, the first wire harness 11 includes a first electric wire 21 and a first exterior member 22 (first exterior tube). More than one first electric wire 21 is provided, for example. The first exterior member 22 has a cylindrical shape, for example. The first exterior member 22 collectively encloses the first electric wires 21. Note that one end portion of each first electric wire 21 is connected to the first device M1 and the other end portion of each first electric wire 21 is connected to the second device M2. The first electric wires 21 are high-voltage electric wires that can support high voltages and large currents.

Each first electric wire 21 includes a first core wire 23 and a first insulating covering 24 that covers the outer peripheral surface of the first core wire 23. The first core wire 23 is made of a flexible conductor that is easy to bend, for example. Note that an example of the flexible conductor is a twisted wire formed by twisting metal strands together, for example. A metal material such as a copper- or aluminum-based material can be used as the material of the first core wire 23, for example.

The first insulating covering 24 covers the outer peripheral surface of the first core wire 23 over the entire circumference thereof, for example. The first insulating covering 24 is made of an insulating material such as a synthetic resin, for example. The first insulating covering 24 can be formed by performing extrusion molding on the first core wire 23, for example.

The first exterior member 22 has an overall elongated tubular shape. The first electric wires 21 are inserted into the internal space of the first exterior member 22. The first exterior member 22 protects the first electric wires 21 from flying objects and water droplets, for example.

As shown in FIG. 2, the first exterior member 22 is constituted by, for example, a corrugated tube made of a synthetic resin. The first exterior member 22 serving as a corrugated tube has a bellows shape in which the diameter repeatedly increases and decreases in the lengthwise direction. That is, the first exterior member 22 has recesses 22a and protrusions 22b that are alternatingly continuous in the lengthwise direction of the first exterior member 22. The recesses 22a and the protrusions 22b each have, for example, an annular shape extending along the circumferential direction of the first exterior member 22. The first exterior member 22 made of a corrugated tube is flexible and can be easily bent. Note that as the constituent material of the first exterior member 22, for example, synthetic resin such as polyolefin, polyamide, polyester, and ABS resin can be used.

### Configuration of Second Wire Harness 12

As shown in FIG. 3, the second wire harness 12 includes a second electric wire 31 and a second exterior member 32 (second exterior tube). More than one second electric wire 31 is provided, for example. The second exterior member 32 has a cylindrical shape, for example. The second exterior member 32 collectively encloses the second electric wires 31, for example. Note that one end portion of each second electric wire 31 is connected to the third device M3, and the other end portion of each second electric wire 31 is connected to the fourth device M4. The second electric wires 31 are low-voltage electric wires.

Each second electric wire 31 includes a second core wire 33 and a second insulating covering 34 that covers the outer peripheral surface of the second core wire 33. The second core wire 33 is formed by a flexible conductor that is easy to bend, for example. Note that an example of the flexible conductor is a twisted wire formed by twisting metal strands together, for example. A metal material such as a copper- or aluminum-based material can be used as the material of the second core wire 33, for example.

The second insulating covering 34 covers the outer peripheral surface of the second core wire 33 over the entire circumference thereof, for example. The second insulating covering 34 is made of an insulating material such as a synthetic resin, for example. The second insulating covering 34 can be formed by performing extrusion molding on the second core wire 33, for example.

The second exterior member 32 has an overall elongated tubular shape. The second electric wires 31 are inserted into the internal space of the second exterior member 32. The second exterior member 32 protects the second electric wires 31 from flying objects and water droplets, for example.

As shown in FIG. 2, the second exterior member 32 is constituted by, for example, a corrugated tube made of synthetic resin. The second exterior member 32 serving as a corrugated tube has a bellows shape in which the diameter repeatedly increases and decreases in the lengthwise direction. That is, the second exterior member 32 has recesses 32a and protrusions 32b that are connected alternatingly in the lengthwise direction of the second exterior member 32. The recesses 32a and the protrusions 32b each have, for example, an annular shape extending along the circumferential direction of the second exterior member 32. The second exterior member 32 made of a corrugated tube is flexible and can be easily bent. Note that as the constituent material of the second exterior member 32, for example, a synthetic resin such as polyolefin, polyamide, polyester, and ABS resin can be used.

As shown in FIG. 3, the first exterior member 22 and the second exterior member 32 are arranged side by side along the X-axis. The X-axis is perpendicular to the lengthwise direction of the first exterior member 22 and the second exterior member 32. Hereinafter, the direction along the X-axis is referred to as an alignment direction X of the first exterior member 22 and the second exterior member 32 in some cases.

### Configuration of First Path Regulating Member 40

As shown in FIGS. 2 and 3, the first path regulating member 40 collectively holds the first exterior member 22 and the second exterior member 32. Also, the first path regulating member 40 is harder than the first exterior member 22 and the second exterior member 32. That is, the first path regulating member 40 has a hardness that makes it more difficult to bend in the direction perpendicular to the lengthwise direction of the first wire harness 11 and the second wire harness 12 compared to the first exterior member 22 and the second exterior member 32. As a result, the first path regulating member 40 regulates the path of the first wire harness 11 and the path of the second wire harness 12. That is, the first path regulating member 40 assists the first wire harness 11 and the second wire harness 12 such that the first wire harness 11 and the second wire harness 12 do not bend under their own weight or the like and deviate from the predetermined path. Accordingly, the first exterior member 22 and the second exterior member 32 are less likely to bend than when the first path regulating member 40 is not attached.

The first path regulating member 40 is partially provided in the lengthwise direction of the first wire harness 11 and the second wire harness 12. The first path regulating member 40 is attached, for example, to a linearly extending portion of the paths of the first wire harness 11 and the second wire harness 12. One or more first path regulating members 40 are provided according to the paths of the first wire harness 11 and the second wire harness 12.

The first path regulating member 40 includes a first main body portion 41 (first main body) that partially covers the outer peripheries of the first exterior member 22 and the second exterior member 32, and a first insertion opening 42.

The first main body portion 41 partially covers the outer peripheries of the first exterior member 22 and the second exterior member 32 aligned in the alignment direction X. The first main body portion 41 extends, for example, linearly along the lengthwise direction of the first exterior member 22 and the second exterior member 32. The transverse cross-sectional shape of the first main body portion 41 is, for example, substantially C-shaped. Note that the transverse cross-sectional shape of the first path regulating member 40 is uniform over the entire length of the first path regulating member 40, for example. Also, the thickness in the radial direction of the first main body portion 41 is, for example, uniform in the circumferential direction.

As shown in FIG. 3, the first main body portion 41 includes a covering portion 43, a pair of arm portions 44a and 44b, a first end portion 45, which is the leading end portion of the arm portion 44a, and a second end portion 46, which is the leading end portion of the arm portion 44b.

The covering portion 43 covers, for example, the sides of the first exterior member 22 and the second exterior member 32 in the Y-axis direction perpendicular to the alignment direction X.

The pair of arm portions 44a and 44b respectively extend from both end portions of the covering portion 43 in the alignment direction X. The pair of arm portions 44a and 44b sandwich the first exterior member 22 and the second exterior member 32 together from both sides in the alignment direction X. Each of the arm portions 44a and 44b extends to the side opposite to the side covered by the covering portion 43 in the Y-axis direction. That is, the first end portion 45 of the arm portion 44a and the second end portion 46 of the arm portion 44b are located on the side opposite to the side covered by the covering portion 43 in the Y-axis direction. The arm portion 44a covers the side of the first exterior member 22 in the alignment direction X. The arm portion 44b covers the side of the second exterior member 32 in the alignment direction X.

The first end portion 45 and the second end portion 46 are both end portions of the first body portion 41 in the circumferential direction. The first end portion 45 and the second end portion 46 face each other while being spaced apart from each other in the circumferential direction of the first main body portion 41. The first insertion opening 42 is formed by the first end portion 45 and the second end portion 46. That is, the gap between the first end portion 45 and the second end portion 46 is configured as the first insertion port 42.

As shown in FIGS. 2 and 3, the first exterior member 22 and the second exterior member 32 are in contact with each other while being sandwiched between the pair of arm portions 44a and 44b. Furthermore, in the present embodiment, the recesses and protrusions of the outer peripheral surface of the first exterior member 22 mesh with the recesses and protrusions of the outer peripheral surface of the second exterior member 32 at least at the portion held by the first path regulating member 40. That is, the protrusions 22b of the first exterior member 22 fit into the recesses 32a of the second exterior member 32, and the protrusions 32b of the second exterior member 32 fit into the recesses 22a of the first exterior member 22. As a result, the size of the composite wire harness 10 can be reduced in the alignment direction X by the meshing amount of the first exterior member 22 and the second exterior member 32 at the holding portion of the first path regulating member 40. Also, the meshing of the first exterior member 22 and the second exterior member 32 can restrict the relative movement of the first exterior member 22 and the second exterior member 32 in the lengthwise direction.

The first insertion port 42 is an opening extending along the lengthwise direction of the first path regulating member 40. Also, the first insertion port 42 is open along the Y-axis. That is, the first insertion opening 42 is open in a direction perpendicular to the alignment direction X. Also, the first insertion port 42 extends over the entire length of the first path regulating member 40. The opening width of the first insertion port 42, that is, the shortest distance between the first end portion 45 and the second end portion 46, is smaller than a length obtained by subtracting the meshing amount of the recesses and protrusions of the first exterior member 22 and the second exterior member 32 from a length obtained by adding together the outer diameter of the first exterior member 22 and the outer diameter of the second exterior member 32. The first exterior member 22 and the second exterior member 32 are inserted into the first insertion port 42 along the Y-axis direction.

The first path regulating member 40 has a first protruding portion 47 (first protrusion) protruding from the inner surface of the first end portion 45 and a second protruding portion 48 (second protrusion) protruding from the inner surface of the second end portion 46. The transverse cross-sectional shape of the first protruding portion 47 and the second protruding portion 48 is, for example, semicircular. The first protruding portion 47 and the second protruding portion 48 extend along the lengthwise direction of the first path regulating member 40, for example. Also, the first protruding portion 47 and the second protruding portion 48 extend over the entire length of the first path regulating member 40, for example.

The first protruding portion 47 protrudes toward the first exterior member 22. The first protruding portion 47 is in contact with the outer surface of the first exterior member 22. Also, the second protruding portion 48 protrudes toward the second exterior member 32. The second protruding portion 48 is in contact with the outer surface of the second exterior member 32. The first protruding portion 47 and the second protruding portion 48 respectively press, for example, the first exterior member 22 and the second exterior member 32. The first exterior member 22 and the second exterior member 32 are elastically sandwiched between the first protruding portion 47 and second protruding portion 48 and the first main body portion 41. As a result, the coupling of the first path regulating member 40 to the first exterior member 22 and the second exterior member 32 is strengthened. Accordingly, movement of the first path regulating member 40 in the lengthwise direction of the first exterior member 22 and the second exterior member 32 is suppressed.

Note that when the first exterior member 22 and the second exterior member 32 are inserted into the first path regulating member 40, the opening width of the first insertion port 42 does not necessarily return to its original width, that is, the width when the first exterior member 22 and the second exterior member 32 are not inserted. Specifically, the elastic deformation by which the arm portions 44a and 44b try to return to their original shapes is blocked by the first exterior member 22 and the second exterior member 32, and therefore the opening width of the first insertion port 42 is slightly wider than the original width in some cases. Also, when the first exterior member 22 and the second exterior member 32 are inserted into the first path regulating member 40, the opening width of the first insertion port 42 returns to its original width in some cases due to the first exterior member 22 and the second exterior member 32 bending due to the pressure of the first path regulating member 40. That is, the opening width of the first insertion port 42 when the first exterior member 22 and the second exterior member 32 are inserted into the first path regulating member 40 is based on the rigidity, ease of bending, and the like of the first exterior member 22, the second exterior member 32, and the first path regulating member 40.

As shown in FIG. 3, in the first path regulating member 40, a leading end 45a in the circumferential direction of the first end portion 45 and a leading end 46a in the circumferential direction of the second end 46 are curved in a view in the lengthwise direction of the first path regulating member 40. In other words, the transverse cross-sectional shapes of the leading end 45a of the first end portion 45 and the leading end 46a of the second end portion 46 are curved shapes. Note that the first insertion port 42 is formed by the leading end 45a of the first end portion 45 and the leading end 46a of the second end portion 46. Also, the first protruding portion 47 protrudes from the inner surface of the leading end 45a of the first end portion 45. The second protruding portion 48 protrudes from the inner surface of the leading end 46a of the second end 46.

Note that as the material of the first path regulating member 40, for example, a synthetic resin such as polypropylene, polyamide, or polyacetal can be used. The first path regulating member 40 can be molded through, for example, a known method such as extrusion molding or injection molding. Note that, as described above, the first path regulating member 40 is harder than the first exterior member 22 and the second exterior member 32, but the constituent material of the first path regulating member 40 does not need to be harder as a raw material than the constituent material of the first exterior member 22 and the constituent material of the second exterior member 32. That is, the constituent material of the first path regulating member 40 may be a harder material or a softer material than the constituent material of the first exterior member 22 and the constituent material of the second exterior member 32. Also, the constituent material of the first path regulating member 40 may be the same material as the constituent material of the first exterior member 22 and the constituent material of the second exterior member 32.

The first path regulating member 40 of this embodiment is made of, for example, a colored synthetic resin material. Here, the color of the synthetic resin material forming the first path regulating member 40 is set to a color that enables the worker to recognize that the wires included in the composite wire harness 10 are high-voltage wires.

Note that the composite wire harness 10 is fixed to the vehicle body by a fixing member (not shown). A plurality of fixing points for fixing to the vehicle body by the fixing member are provided in the path of the composite wire harness 10. The fixing points are set in a section where the first path regulating member 40 is provided or a section where the first path regulating member 40 is not provided.

The actions of this embodiment will be described.

According to the composite wire harness 10 of the present embodiment, at the portion where the first path regulating member 40 is attached, the rigidity of the first path regulating member 40 prevents the first wire harness 11 and the second wire harness 12 from bending due to their own weight and the like. That is, the first path regulating member 40 regulates the paths of both the first wire harness 11 and the second wire harness 12.

Note that in the conventional configuration, for example, the first exterior member 22 is a hard pipe member such as a metal pipe, and the pipe member realizes both the protection of the first electric wire 21 and path regulation. In such a configuration, the pipe member becomes long, and a bending process of bending the pipe member with a bending machine or the like is required at the bent portion in the path of the first electric wire 21. The bending process is a complicated task. However, in the composite wire harness 10 of the present embodiment, since the first path regulating member 40 is attached to the straight portion of the path of the composite wire harness 10, the conventional bending process using a bending machine or the like is unnecessary.

Effects of the first embodiment will be described.

(1) The first insertion opening 42 of the first path regulating member 40 is an opening extending in the lengthwise direction of the first path regulating member 40 and extends over the entire length of the first path regulating member 40. According to this configuration, after terminal processing such as attaching a connector to each end portion in the lengthwise direction of the first electric wire 21 and the second electric wire 31 is performed, it is possible to attach the first path regulating member 40 to the first exterior member 22 and the second exterior member 32 through the first insertion port 42. In this manner, since the first path regulating member 40 can be retrofitted to the first exterior member 22 and the second exterior member 32, the assembly workability of the composite wire harness 10 can be improved.

Also, the first path regulating member 40 collectively holds the first exterior member 22 and the second exterior member 32 and regulates the paths of the first wire harness 11 and the second wire harness 12. That is, since the paths of a plurality of wire harnesses can be regulated by one first path regulating member 40, it is possible to contribute to reducing the number of components of the composite wire harness 10.

Also, the first path regulating member 40 is harder than the first exterior member 22 and the second exterior member 32. That is, the first path regulating member 40 has a hardness that makes it more difficult to bend than the first exterior member 22 and the second exterior member 32. According to this configuration, the paths of the first wire harness 11 and the second wire harness 12 can be more firmly regulated by the hard first path regulating member 40.

(2) The first path regulating member 40 includes a first protruding portion 47 that protrudes from the inner surface of the first end portion 45 and comes into contact with the outer surface of the first exterior member 22, and a second protruding portion 48 that protrudes from the inner surface of the second end portion 46 and comes into contact with the outer surface of the second exterior member 32. According to this configuration, the first protruding portion 47 and the second protruding portion 48 can prevent the first exterior member 22 and the second exterior member 32 from deviating from the first path regulating member 40 through the first insertion port 42. As a result, unintended deviation of the first path regulating member 40 is suppressed, and therefore the assembly workability of the composite wire harness 10 can be further improved.

(3) The first path regulating member 40 is made of a colored synthetic resin material. According to this configuration, the first path regulating member 40 can be given a desired color without coating its surface. As a result, by making the color of the first path regulating member 40 a color that enables the worker to recognize that the composite wire harness 10 includes the first electric wire 21, which is a high-voltage electric wire, it is possible to prompt the worker to be careful not to cut the first electric wire 21 by mistake.

(4) Each of the leading end 45a of the first end portion 45 and the leading end 46a of the second end portion 46 is curved in a view in the lengthwise direction of the first path regulating member 40. For this reason, the first exterior member 22 and the second exterior member 32 can be smoothly inserted into the first path regulating member 40 through the first insertion opening 42 formed at the respective leading ends 45a and 46a. Also, when the first exterior member 22 and the second exterior member 32 are inserted into the first path regulating member 40 through the first insertion port 42, the first exterior member 22 and the second exterior member 32 are less likely to be damaged.

(5) The transverse cross-sectional shape of the first path regulating member 40 is the same over the entire length of the first path regulating member 40. According to such a configuration, the first path regulating member 40 can be easily manufactured by using an extruder that extrudes the raw material of the first path regulating member 40 in the lengthwise direction. Also, a single extruder can be used to manufacture a plurality of types of first path regulating members 40 having different dimensions in the lengthwise direction.

(6) The first protruding portion 47 and the second protruding portion 48 extend over the entire length of the first path regulating member 40. With such a configuration, the bending rigidity of the first path regulating member 40 can be enhanced. Also, the first protruding portion 47 and the second protruding portion 48 respectively come into contact with the outer surfaces of the first exterior member 22 and the second exterior member 32 over the entire length of the first path regulating member 40. For this reason, it is possible to prevent the first path regulating member 40 from being detached from the first exterior member 22 and the second exterior member 32 through the first insertion port 42 over the entire length of the first path regulating member 40.

### Second Embodiment

Next, a second embodiment of the composite wire harness will be described. Note that in this embodiment, differences from the first embodiment will be mainly described, configurations that are the same as in the first embodiment will be denoted by the same reference signs, and some or all of the description thereof will be omitted in some cases.

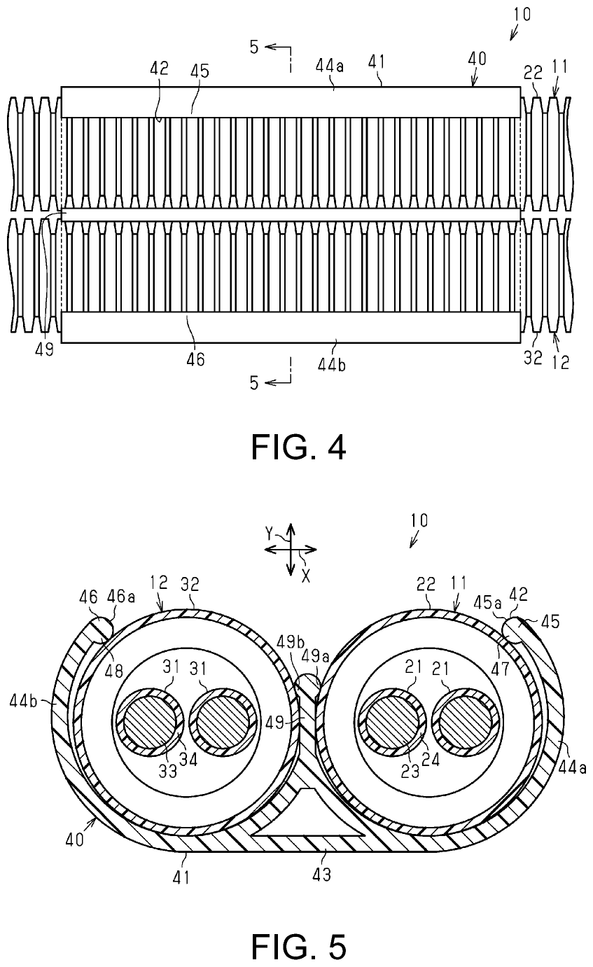

As shown in FIGS. 4 and 5, the first path regulating member 40 has a partition portion 49 protruding from the first main body portion 41 toward the first insertion port 42. The partition portion 49 extends over the entire length of the first path regulating member 40, for example. The partition portion 49 is located between the first exterior member 22 and the second exterior member 32. That is, the partition portion 49 partitions the first exterior member 22 and the second exterior member 32 from each other. The first exterior member 22 is arranged between the partition portion 49 and the first end portion 45. The second exterior member 32 is arranged between the partition portion 49 and the second end portion 46.

The partition portion 49 has a first protrusion portion 49a that protrudes from the leading end portion of the partition portion 49 toward the first exterior member 22, and a second protrusion portion 49b that protrudes from the leading end portion of the partition portion 49 toward the second exterior member 32. The first protrusion portion 49a is in contact with the outer peripheral surface of the first exterior member 22. The second protrusion portion 49b is in contact with the outer peripheral surface of the second exterior member 32.

Note that the shortest distance between the leading end portion of the partition portion 49 and the first end portion 45 is smaller than the outer diameter of the first exterior member 22. Also, the shortest distance between the leading end portion of the partition portion 49 and the second end portion 46 is smaller than the outer diameter of the second exterior member 32.

Effects of the second embodiment will be described.

(7) In the first path regulating member 40, the partition portion 49 separates the portion where the first exterior member 22 is arranged and the portion where the second exterior member 32 is arranged from each other. For this reason, workability when assembling the first exterior member 22 and the second exterior member 32 to the first path regulating member 40 can be improved.

(8) The partition portion 49 has a first protrusion portion 49a that protrudes from the leading end portion of the partition portion 49 toward the first exterior member 22. Thus, the first protrusion portion 49a can prevent the first exterior member 22 from deviating from the first path regulating member 40. Also, the partition portion 49 has a second protrusion portion 49b protruding from the leading end portion of the partition portion 49 toward the second exterior member 32. As a result, the second protrusion portion 49b can prevent the second exterior member 32 from deviating from the first path regulating member 40.

### Third Embodiment

Next, a third embodiment of the composite wire harness will be described. Note that in this embodiment, differences from the first embodiment will be mainly described, configurations that are the same as in the first embodiment will be denoted by the same reference signs, and some or all of the description thereof will be omitted in some cases.

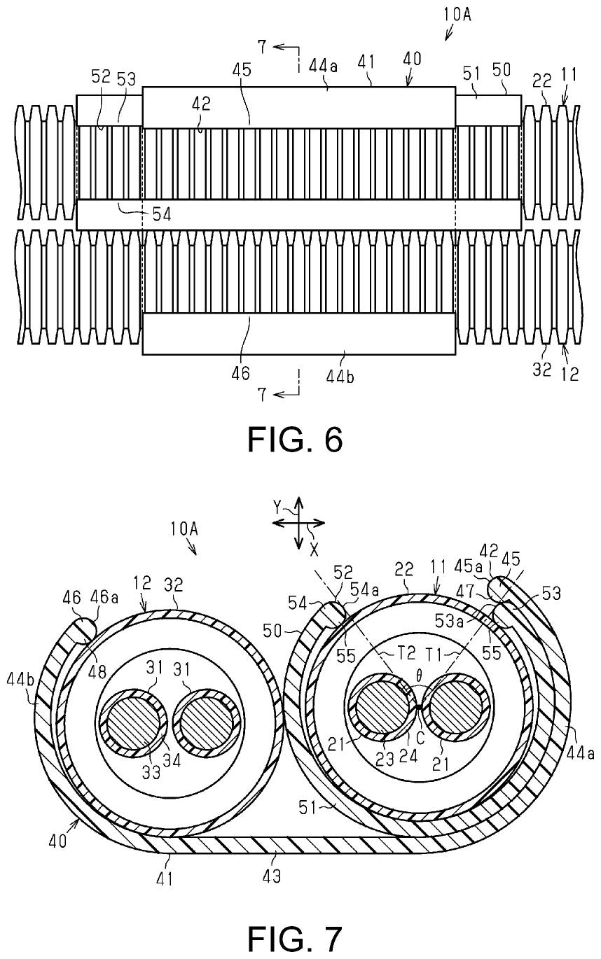

As shown in FIGS. 6 and 7, a composite wire harness 10A of the present embodiment includes a second path regulating member 50 (second path regulator) attached to the outer periphery of the first exterior member 22. The composite wire harness 10A also includes a first path regulating member 40 that collectively holds the first wire harness 11 and the second wire harness 12. The first path regulating member 40 is arranged outside of the second path regulating member 50. That is, the second path regulating member 50 is arranged between the outer peripheral surface of the first exterior member 22 and the first path regulating member 40.

### Configuration of Second Path Regulating Member 50

The second path regulating member 50 partially covers the outer periphery of the first exterior member 22 in the circumferential direction. Also, the second path regulating member 50 is harder than the first exterior member 22. That is, the second path regulating member 50 has a hardness that makes it more difficult to bend in the direction perpendicular to the lengthwise direction of the first wire harness 11 compared to the first exterior member 22. As a result, the second path regulating member 50 assists the first exterior member 22 such that the first exterior member 22 does not bend due to its own weight or the like and deviate from the predetermined path. That is, the first exterior member 22 is less likely to bend than when the second path regulating member 50 is not attached.

The second path regulating member 50 is partially provided in the lengthwise direction of the first exterior member 22. The second path regulating member 50 is attached, for example, to a portion of the path of the first wire harness 11 that extends linearly. One or more second path regulating members 50 are provided according to the path of the first wire harness 11.

As shown in FIG. 7, the second path regulating member 50 has a second main body portion 51 (second main body) that partially covers the outer periphery of the first exterior member 22 in the circumferential direction, and a second insertion opening 52.

The second main body portion 51 partially covers the outer peripheral surface of the first exterior member 22 in the circumferential direction. For example, the second body portion 51 covers an area larger than half of the outer periphery of the first exterior member 22. Also, the second main body portion 51 extends along the lengthwise direction of the first exterior member 22. The cross-sectional shape of the second main body portion 51 is, for example, arc-shaped. Note that the thickness of the second main body portion 51 in the radial direction is, for example, uniform in the circumferential direction. Note that the cross-sectional shape of the second path regulating member 50 is uniform over the entire length of the second path regulating member 50, for example. Also, the central axis C in the transverse cross section of the second main body portion 51 forms, for example, a straight line. That is, the second main body portion 51 has a shape extending linearly in one direction.

The second main body portion 51 has a third end portion 53 and a fourth end portion 54, which are both end portions of the second path regulating member 50 in the circumferential direction. The third end portion 53 and the fourth end portion 54 face each other while being spaced apart from each other in the circumferential direction of the second path regulating member 50. The second insertion port 52 is formed by the third end portion 53 and the fourth end portion 54 of the second main body portion 51. That is, the gap between the third end portion 53 and the fourth end portion 54 is formed as the second insertion port 52.

The second insertion port 52 is an opening extending along the lengthwise direction of the second path regulating member 50. Also, the second insertion port 52 extends over the entire length of the second path regulating member 50. The opening width of the second insertion port 52, that is, the shortest distance between the third end portion 53 and the fourth end portion 54 is smaller than the outer diameter of first exterior member 22. The first exterior member 22 is inserted into the second insertion port 52 along a direction perpendicular to the lengthwise direction of the second path regulating member 50.

In the transverse cross section of the second path regulating member 50, a tangent to the third end portion 53 passing through the central axis C of the second main body portion 51 is defined as a tangent T1, and a tangent to the fourth end portion 54 passing through the central axis line C is defined as a tangent T2. The opening angle θ of the second insertion opening 52 in the circumferential direction of the second path regulating member 50 is, for example, within the range of 60° to 120°. Note that the opening angle θ of the second insertion port 52 is the angle about the center axis C of the second main body portion 51, that is, the angle formed by the tangents T1 and T2.

The second path regulating member 50 has third protruding portions 55 (third protrusions) protruding from the respective inner surfaces of the third end portion 53 and the fourth end portion 54. The transverse cross-sectional shape of each third protruding portion 55 is, for example, semicircular. Each third protruding portion 55 extends along the lengthwise direction of the second path regulating member 50, for example. Also, each third protruding portion 55 extends over the entire length of the second path regulating member 50, for example.

Each third protrusion 55 protrudes toward the first exterior member 22. Each third protruding portion 55 is in contact with the outer surface of the first exterior member 22. Each third protruding portion 55 presses the first exterior member 22, for example. The first exterior member 22 is elastically sandwiched between the third protruding portions 55 and the second main body portion 51. As a result, the coupling of the second path regulating member 50 to the first exterior member 22 is strengthened. Accordingly, movement of the second path regulating member 50 attached to the outer periphery of the first exterior member 22 in the lengthwise direction of the first exterior member 22 is suppressed.

Note that when the first exterior member 22 is inserted into the second path regulating member 50, the opening width of the second insertion port 52 does not necessarily return to its original width, that is, the width when the first exterior member 22 is not inserted. Specifically, the elastic deformation by which the second path regulating member 50 attempts to return to its original shape is hindered by the first exterior member 22, whereby the opening width of the second insertion port 52 is slightly larger than the original width in some cases. Also, when the first exterior member 22 is inserted in the second path regulating member 50, the first exterior member 22 is bent due to the pressure of the second path regulating member 50, whereby the opening width of the second insertion port 52 returns to its original width in some cases. That is, the above-described opening width when the first exterior member 22 is inserted into the second path regulating member 50 is based on the rigidity and ease of bending of the first exterior member 22 and the second path regulating member 50.

In the second path regulating member 50, each of the leading end 53a of the third end portion 53 in the circumferential direction and the leading end 54a of the fourth end portion 54 in the circumferential direction is curved in a view in the lengthwise direction of the second path regulating member 50. In other words, the leading end 53a of the third end portion 53 and the leading end 54a of the fourth end portion 54 have a curved cross-sectional shape. Note that the second insertion port 52 is formed by the leading end 53a of the third end portion 53 and the leading end 54a of the fourth end portion 54. Also, the third protruding portion 55 protrudes from the inner surface of each of the leading end 53a of the third end portion 53 and the leading end 54a of the fourth end portion 54.

As the material of the second path regulating member 50, for example, a synthetic resin such as polypropylene, polyamide, and polyacetal can be used. The second path regulating member 50 can be molded using a known method such as extrusion molding or injection molding. Note that, as described above, the second path regulating member 50 is harder than the first exterior member 22, but the constituent material of the second path regulating member 50 does not need to be a material that is harder as a raw material than the constituent material of the first exterior member 22. That is, the constituent material of the second path regulating member 50 may be a harder material or a softer material than the constituent material of the first exterior member 22. Also, the constituent material of the second path regulating member 50 may be the same material as the constituent material of the first exterior member 22.

The second path regulating member 50 of this embodiment is made of, for example, a colored synthetic resin material. Here, the color of the synthetic resin material forming the second path regulating member 50 is set to a color that enables the operator to recognize that the first electric wire 21 included in the first wire harness 11 is a high-voltage electric wire. Also, in the present embodiment, the second path regulating member 50 has the same color as the first path regulating member 40.

The second path regulating member 50 is arranged inside the first main body portion 41 of the first path regulating member 40. Also, the second path regulating member 50 is longer than the first path regulating member 40 in the lengthwise direction of the first wire harness 11, for example. The arm portion 44a of the first main body portion 41 is in contact with the second main body portion 51 of the second path regulating member 50. The arm portion 44a presses the second main body portion 51 in the alignment direction X, for example. Also, the first insertion opening 42 of the first path regulating member 40 and the second insertion opening 52 of the second path regulating member 50 are open in the same direction along the Y axis, for example.

The first end portion 45 of the first main body portion 41 extends, for example, farther than the third end portion 53 of the second main body portion 51 in the circumferential direction of the first exterior member 22. As a result, the first end portion 45 faces the outer peripheral surface of the first exterior member 22. Note that in the configuration shown in FIG. 7, in the first path regulating member 40, the first protruding portion 47 of the first end portion 45 is not in contact with the outer peripheral surface of the first exterior member 22; but there is no limitation to this, and the first protruding portion 47 may also be configured to come into contact with the outer peripheral surface of the first exterior member 22.

Effects of the third embodiment will be described.

(9) The paths of the first wire harness 11 and the second wire harness 12 can be more favorably regulated by the first path regulating member 40 and the second path regulating member 50.

Also, since the second path regulating member 50 attached to the first exterior member 22 is included inside the first path regulating member 40, the first exterior member 22 can be more favorably protected from flying objects and the like. As a result, it is possible to contribute to improving the durability of the composite wire harness 10A.

In addition, since the first exterior member 22 is double-covered by the first path regulating member 40 and the second path regulating member 50, heat transfer from the outside to the first exterior member 22 can be suppressed more favorably.

Also, the second insertion port 52 of the second path regulating member 50 is an opening extending in the lengthwise direction of the second path regulating member 50 and extends over the entire length of the second path regulating member 50. As a result, the second path regulating member 50 can be attached to the first exterior member 22 from the second insertion port 52 after performing terminal processing such as attaching connectors to the end portions of the first electric wire 21 in the lengthwise direction. In this manner, since the second path regulating member 50 can be retrofitted to the first exterior member 22, it is possible to contribute to improving the assembly workability of the composite wire harness 10A.

Also, the first path regulating member 40 collectively holds the first exterior member 22 and the second exterior member 32. For this reason, the first path regulating member 40 can couple the first exterior member 22 and the second exterior member 32 to each other.

Also, the second path regulating member 50 is harder than the first exterior member 22. That is, the second path regulating member 50 has a hardness that makes it more difficult to bend than the first exterior member 22. According to this configuration, the path of the first wire harness 11 can be more firmly regulated by the hard second path regulating member 50.

(10) The second path regulating member 50 is longer than the first path regulating member 40 in the lengthwise direction of the first wire harness 11. According to this configuration, for example, when the first wire harness 11 requires path regulation in a section longer than that of the second wire harness 12, this is not handled by lengthening the first path regulating member 40, but by lengthening the second path regulating member 50 attached to the first exterior member 22, whereby it is possible to regulate only the locations that require path regulation. That is, it is not necessary to expand the first path regulating member 40 to a section where path regulation is not required in the second wire harness 12, and as a result, it is possible to contribute to reducing the size of the first path regulating member 40, and contribute to reducing the weight of the composite wire harness 10A.

(11) The second path regulating member 50 has the third protruding portions 55 that protrude from the respective inner surfaces of the third end portion 53 and the fourth end portion 54 and comes into contact with the outer surface of the first exterior member 22. According to this configuration, the third protruding portion 55 can prevent the first exterior member 22 from deviating from the second path regulating member 50 through the second insertion port 52. As a result, unintended deviation of the second path regulating member 50 is prevented, and therefore the assembly workability of the composite wire harness 10A can be further improved.

(12) The second path regulating member 50 is made of a colored synthetic resin material. According to this configuration, the second path regulating member 50 can be given a desired color without coating its surface. As a result, by making the color of the second path regulating member 50 a color that enables the worker to recognize that the first wire harness 11 includes the first electric wire 21 as a high-voltage electric wire, it is possible to prompt the worker to be careful not to cut the first wire harness 11 by mistake.

(13) The second path regulating member 50 has the same color as the first path regulating member 40. This allows the operator to preferably recognize that the composite wire harness 10A includes a high-voltage wire.

(14) The leading end 53a of the third end portion 53 and the leading end 54a of the fourth end portion 54 are each curved in a view in the lengthwise direction of the second path regulating member 50. For this reason, the first exterior member 22 can be smoothly inserted into the second path regulating member 50 through the second insertion openings 52 formed at the leading ends 53a and 54a. Also, when the first exterior member 22 is inserted into the second path regulating member 50 through the second insertion port 52, the first exterior member 22 is less likely to be damaged.

(15) The transverse cross-sectional shape of the second path regulating member 50 is the same over the entire length of the second path regulating member 50. According to such a configuration, the second path regulating member 50 can be easily manufactured by using an extruder that extrudes the raw material of the second path regulating member 50 in the lengthwise direction. Also, a single extruder can be used to manufacture a plurality of types of second path regulating members 50 having different dimensions in the lengthwise direction.

(16) The third protruding portion 55 extends over the entire length of the second path regulating member 50. With such a configuration, the bending rigidity of the second path regulating member 50 can be enhanced. Also, the third protruding portion 55 comes into contact with the outer surface of the first exterior member 22 over the entire length of the second path regulating member 50. For this reason, detachment of the second path regulating member 50 from the first exterior member 22 through the second insertion port 52 can be suppressed over the entire length of the second path regulating member 50.

### Fourth Embodiment

Next, a fourth embodiment of the composite wire harness will be described. Note that in this embodiment, differences from the first embodiment will be mainly described, configurations that are the same as in the first embodiment will be denoted by the same reference signs, and some or all of the description thereof will be omitted in some cases.

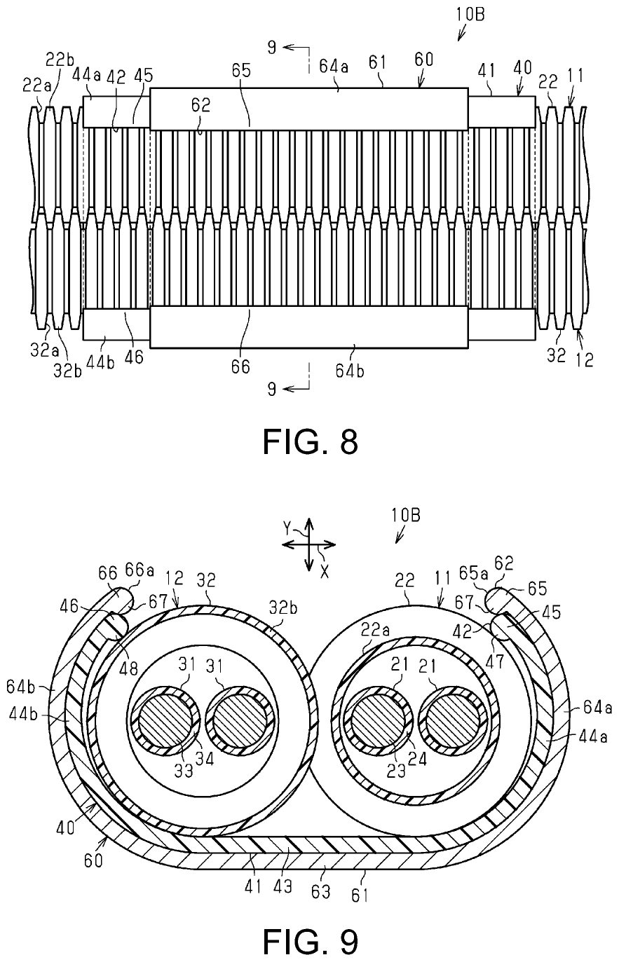

As shown in FIGS. 8 and 9, a composite wire harness 10B of the present embodiment includes a third path regulating member 60 attached to the outer periphery of the first path regulating member 40. The third path regulating member 60 regulates the paths of the first wire harness 11 and the second wire harness 12.

### Configuration of Third Path Regulating Member 60

As shown in FIGS. 8 and 9, the third path regulating member 60 includes a third main body portion 61 (third main body) that partially covers the outer periphery of the first path regulating member 40, and a third insertion port 62. Note that the third path regulating member 60 is made of, for example, a metal material. The third path regulating member 60 can be formed, for example, using a method such as pressing a metal plate or casting.

The third main body portion 61 has a shape that is one size larger than the first main body portion 41 of the first path regulating member 40. The third main body portion 61 extends linearly along the lengthwise direction of the first exterior member 22 and the second exterior member 32, for example. That is, the third main body portion 61 extends in the lengthwise direction of the first main body portion 41. The transverse cross-sectional shape of the third main body portion 61 is, for example, substantially C-shaped. Note that the transverse cross-sectional shape of the third path regulating member 60 is uniform over the entire length of the third path regulating member 60, for example. Also, the radial thickness of the third main body portion 61 is, for example, uniform in the circumferential direction. Also, the third main body portion 61 is shorter than the first main body portion 41 in the lengthwise direction of the first path regulating member 40, for example.

As shown in FIG. 9, the third main body portion 61 includes a covering portion 63, a pair of arm portions 64a and 64b, a fifth end portion 65, which is the leading end portion of the arm portion 64a, and a sixth end portion 66, which is the leading end portion of the arm portion 64b.

The covering portion 63 covers the outer side of the covering portion 43 in the Y-axis direction perpendicular to the alignment direction X, for example. The covering portion 63 is in contact with the covering portion 43, for example.

The pair of arm portions 64a and 64b respectively extend from both end portions of the covering portion 63 in the alignment direction X. The pair of arm portions 64a and 64b sandwich the first path regulating member 40 from both sides in the alignment direction X. The arm portion 64a is in contact with the arm portion 44a of the first path regulating member 40. Also, the arm portion 64b is in contact with the arm portion 44b of the first path regulating member 40.

The fifth end portion 65, which is the leading end portion of the arm portion 64a, extends farther than the first end portion 45 of the first main body portion 41 in the circumferential direction of the first exterior member 22, for example. As a result, the fifth end portion 65 faces the outer peripheral surface of the first exterior member 22. Also, the sixth end portion 66, which is the leading end portion of the arm portion 64b, extends farther than the second end portion 46 of the first main body portion 41 in the circumferential direction of the second exterior member 32, for example. As a result, the sixth end portion 66 faces the outer peripheral surface of the second exterior member 32.

The fifth end portion 65 and the sixth end portion 66 are both end portions of the third main body portion 61 in the circumferential direction. The fifth end portion 65 and the sixth end portion 66 are located on the side opposite to the side covered by the covering portion 63 in the Y-axis direction. The fifth end portion 65 and the sixth end portion 66 face each other while being spaced apart from each other in the circumferential direction of the third main body portion 61. The third insertion opening 62 is formed by the fifth end portion 65 and the sixth end portion 66. That is, the gap between the fifth end portion 65 and the sixth end portion 66 is formed as the third insertion port 62.

The third insertion port 62 is an opening extending along the lengthwise direction of the third path regulating member 60. Also, the third insertion port 62 is open along the Y-axis. That is, the third insertion opening 62 is open in a direction perpendicular to the alignment direction X. Also, the third insertion port 62 extends over the entire length of the third path regulating member 60. The opening width of the third insertion port 62, that is, the shortest distance between the fifth end portion 65 and the sixth end portion 66, is smaller than the dimension of the first path regulating member 40 in the alignment direction X. The first path regulating member 40 is inserted into the third insertion port 62 along the Y-axis direction.

The third path regulating member 60 has fourth protruding portions 67 protruding from the respective inner surfaces of the fifth end portion 65 and the sixth end portion 66. The transverse cross-sectional shape of each fourth protruding portion 67 is, for example, semicircular. Each fourth protruding portion 67 extends along the lengthwise direction of the third path regulating member 60, for example. Also, each fourth protruding portion 67 extends over the entire length of the third path regulating member 60, for example.

The fourth protruding portion 67 provided on the fifth end portion 65 is in contact with the first end portion 45 of the first main body portion 41, for example. Also, the fourth protruding portion 67 provided on the sixth end portion 66 is in contact with the second end portion 46 of the first main body portion 41, for example. Note that in the configuration shown in FIG. 9, the fourth protruding portion 67 is not in contact with the outer peripheral surface of the first exterior member 22 and the outer peripheral surface of the second exterior member 32, but there is no limitation to this, and the fourth protruding portions 67 may also be configured to come into contact with the outer peripheral surface of the first exterior member 22 and the outer peripheral surface of the second exterior member 32, respectively.

As shown in FIG. 9, in the third path regulating member 60, each of the leading end 65a of the fifth end portion 65 in the circumferential direction and the leading end 66a of the sixth end portion 66 in the circumferential direction is curved in a view in the lengthwise direction of the third path regulating member 60. In other words, the transverse cross-sectional shapes of the leading end 65a of the fifth end portion 65 and the leading end 66a of the sixth end portion 66 are curved. Note that the third insertion port 62 is formed by the leading end 65a of the fifth end portion 65 and the leading end 66a of the sixth end portion 66. Also, the fourth protruding portions 67 protrude from the respective inner surfaces of the leading end 65a of the fifth end portion 65 and the leading end 66a of the sixth end portion 66.

The first path regulating member 40 is provided between the first and second exterior members 22 and 32 and the third path regulating member 60. The first insertion port 42 of the first path regulating member 40 and the third insertion port 62 of the third path regulating member 60 are open in the same direction along the Y axis, for example.

The third path regulating member 60 is harder than the first exterior member 22 and the second exterior member 32. That is, the third path regulating member 60 has a hardness that makes it more difficult to bend in the direction perpendicular to the lengthwise direction of the first wire harness 11 and the second wire harness 12 compared to the first exterior member 22 and the second exterior member 32. As a result, the third path regulating member 60 regulates the path of the first wire harness 11 and the path of the second wire harness 12. That is, the first exterior member 22 and the second exterior member 32 are less likely to bend compared to the state in which the third path regulating member 60 is not attached.

Effects of the fourth embodiment will be described.

(17) With the first path regulating member 40 and the third path regulating member 60, the paths of the first wire harness 11 and the second wire harness 12 can be more preferably regulated.

Also, since the third path regulating member 60 is included outside the first path regulating member 40, the first exterior member 22 and the second exterior member 32 can be more preferably protected from flying objects and the like. As a result, it is possible to contribute to improving the durability of the composite wire harness 10B.

Also, since the first exterior member 22 and the second exterior member 32 are double-covered by the first path regulating member 40 and the third path regulating member 60, heat transfer from the outside to the first exterior member 22 and the second exterior member 32 can be more favorably suppressed.

Also, the third insertion port 62 of the third path regulating member 60 is an opening extending in the lengthwise direction of the third path regulating member 60 and extends over the entire length of the third path regulating member 60. As a result, the third path regulating member 60 can be retrofitted through the third insertion opening 62, and thus it is possible to contribute to improving the assembly workability of the composite wire harness 10B.

Also, the third path regulating member 60 is harder than the first exterior member 22 and the second exterior member 32. That is, the third path regulating member 60 has a hardness that makes it more difficult to bend than the first exterior member 22 and the second exterior member 32. According to this configuration, the paths of the first wire harness 11 and the second wire harness 12 can be more firmly regulated by the hard third path regulating member 60.

(18) The third path regulating member 60 is shorter than the first path regulating member 40 in the lengthwise direction of the first path regulating member 40. According to this configuration, it is possible to provide the third path regulating member 60 only at a location where the third path regulating member 60 is required in the composite wire harness 10B. Accordingly, it is not necessary to extend the third path regulating member 60 to a location where the third path regulating member 60 is not required, and thus it is possible to contribute to a reduction in the size of the third path regulating member 60, and consequently to contribute to a reduction in the weight of the composite wire harness 10B.

(19) The third path regulating member 60 is made of a metal material. According to this configuration, it is possible to effectively block heat transmitted from the outside to the first exterior member 22 and the second exterior member 32 with use of the third path regulating member 60 made of the metal material.

(20) The first path regulating member 40 provided between the first and second exterior members 22 and 32 and the third path regulating member 60 is made of a synthetic resin material. For this reason, the first path regulating member 40 made of synthetic resin can prevent the third path regulating member 60 made of metal from coming into contact with the first exterior member 22 and the second exterior member 32. As a result, wear of the first exterior member 22 and the second exterior member 32 due to contact with the third path regulating member 60 made of metal can be suppressed.

### Fifth Embodiment

Next, a fifth embodiment of the composite wire harness will be described. Note that in this embodiment, differences from the second embodiment will be mainly described, configurations that are the same as in the second embodiment will be denoted by the same reference signs, and some or all of the description thereof will be omitted in some cases.

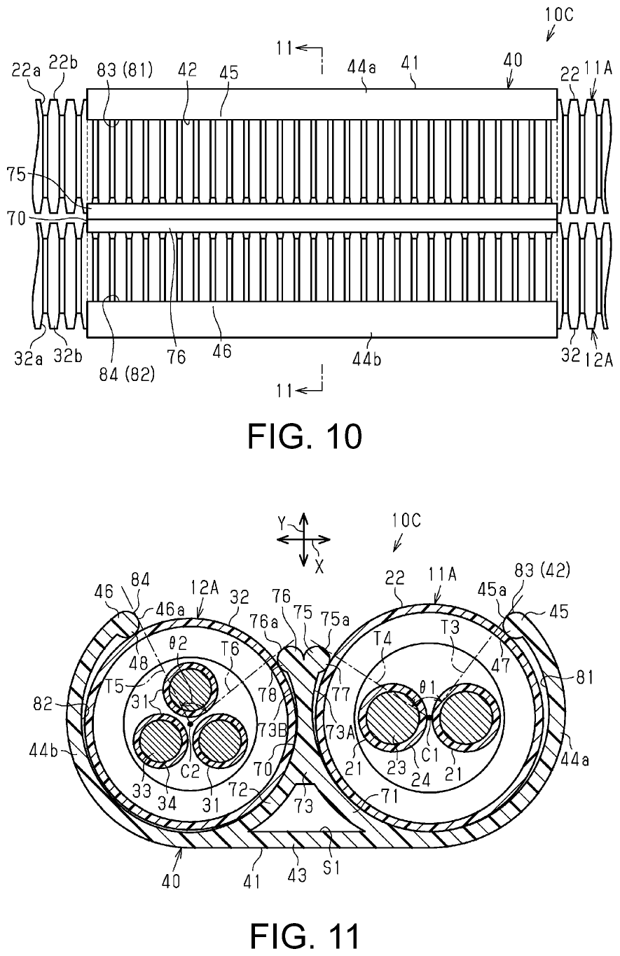

As shown in FIGS. 10 and 11, the composite wire harness 10C of the present embodiment includes a first wire harness 11A, a second wire harness 12A, and a first path regulating member 40 attached to the first wire harness 11A and the second wire harness 12A. The first wire harness 11A and the second wire harness 12A are arranged side by side. The first wire harness 11A and the second wire harness 12A, for example, have outer shapes of different sizes. The first wire harness 11A has, for example, a larger outer shape than the second wire harness 12A.

### Configuration of First Wire Harness 11A and Second Wire Harness 12A

As shown in FIG. 11, the first wire harness 11A has two first electric wires 21 and a tubular first exterior member 22 that collectively surrounds the two first electric wires 21. The second wire harness 12A has three second electric wires 31 and a tubular second exterior member 32 that collectively surrounds the three second electric wires 31.

The two first electric wires 21 are electric wires that form a direct-current circuit. The two first electric wires 21 are, for example, a plus-side high-voltage electric wire and a minus-side high-voltage electric wire. The three second electric wires 31 are electric wires forming a three-phase circuit. The three second electric wires 31 are, for example, a three-phase cable. Each first electric wire 21 has a larger outer shape than each second electric wire 31, for example. Here, the first electric wires 21 and the second electric wires 31 of the present embodiment all have cylindrical shapes. For example, the outer diameter of each first electric wire 21 is larger than the outer diameter of each second electric wire 31. The first exterior member 22 has a larger outer shape than the second exterior member 32, for example. Here, both the first exterior member 22 and the second exterior member 32 of this embodiment are formed in a cylindrical shape. For example, the outer diameter of the first exterior member 22 is larger than the outer diameter of the second exterior member 32.

### Configuration of First Path Regulating Member 40

The first path regulating member 40 has a first main body portion 41 and a first insertion port 42. The first main body portion 41 has a covering portion 43, a pair of arm portions 44a and 44b, a first end portion 45, and a second end portion 46. The covering portion 43 is formed in a flat plate shape parallel to the lengthwise direction and the alignment direction X of the first path regulating member 40, for example. The arm portions 44a and 44b are formed in plate shapes that curve in the form of arcs that protrude toward opposite sides in a view in the lengthwise direction of the first path regulating member 40. The arm portion 44a is, for example, formed in a shape that is curved in the form of an arc along the outer peripheral surface of the first exterior member 22 in a view in the lengthwise direction of the first path regulating member 40. The arm portion 44b is, for example, formed in a shape that is curved in the form of an arc along the outer peripheral surface of the second exterior member 32 in a view in the lengthwise direction of the first path regulating member 40.

The first path regulating member 40 has a partition portion 70 (partition) protruding from the covering portion 43 toward the first insertion port 42. As shown in FIG. 10, the partition portion 70 extends along the lengthwise direction of the first path regulating member 40, for example. The partition portion 70 extends over the entire length of the first path regulating member 40, for example.

As shown in FIG. 11, the partition portion 70 is located between the first exterior member 22 and the second exterior member 32. That is, the partition portion 70 partitions the first exterior member 22 and the second exterior member 32 from each other. The first exterior member 22 is arranged between the partition portion 70 and the arm portion 44a. The second exterior member 32 is arranged between the partition portion 70 and the arm portion 44b. In other words, in the first path regulating member 40, the first accommodating portion 81 in which the first exterior member 22 is accommodated is formed by the space surrounded by the partition portion 70, the arm portion 44a, and part of the covering portion 43. Also, in the first path regulating member 40, the space surrounded by the partition portion 70, the arm portion 44b, and part of the covering portion 43 forms a second accommodating portion 82 in which the second exterior member 32 is accommodated. The partition portion 70 partitions the first accommodation portion 81 and the second accommodation portion 82 from each other. In other words, the first path regulating member 40 of this embodiment has a first accommodating portion 81, a second accommodating portion 82, and a partition portion 70 that partitions the first accommodating portion 81 and the second accommodating portion 82 from each other.

### Schematic Configuration of First Accommodating Portion 81 and Second Accommodating Portion 82

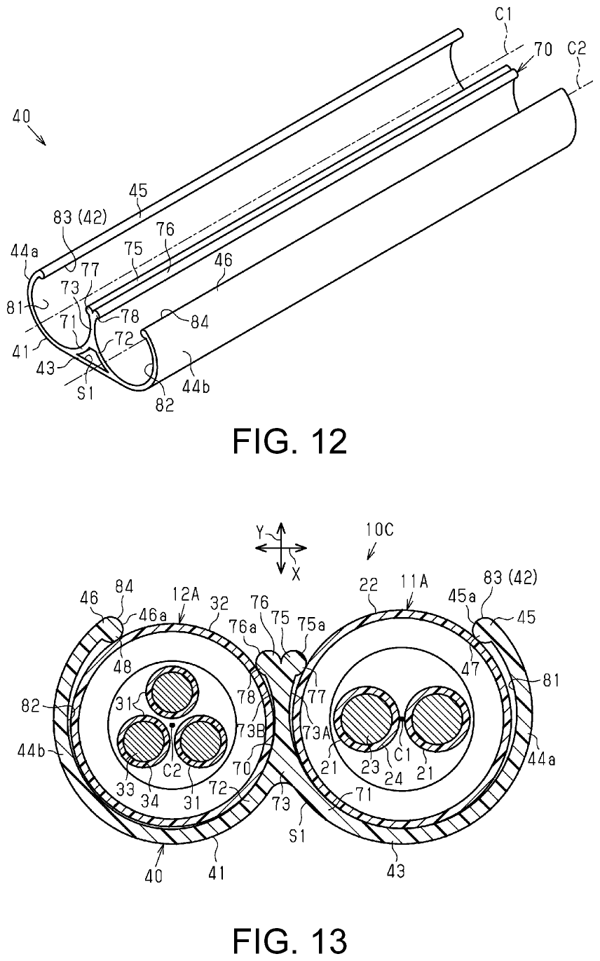

As shown in FIG. 12, each of the first accommodating portion 81 and the second accommodating portion 82 extends along the lengthwise direction of the first path regulating member 40. Each of the first accommodating portion 81 and the second accommodating portion 82 extends over the entire length of the first path regulating member 40.

The first accommodating portion 81 has a first accommodation port 83 that is open in a direction perpendicular to the lengthwise direction of the first path regulating member 40. The second accommodating portion 82 has a second accommodation port 84 that is open in a direction perpendicular to the lengthwise direction of the first path regulating member 40. Each of the first accommodation port 83 and the second accommodation port 84 extends over the entire length of the first path regulating member 40 along the lengthwise direction of the first path regulating member 40. The first accommodation port 83 and the second accommodation port 84 constitute the first insertion port 42.

As shown in FIG. 11, the transverse cross-sectional shape of the inner surface of the first accommodating portion 81 is, for example, arc-shaped. The transverse cross-sectional shape of the inner surface of the first accommodating portion 81 is formed in a C shape having the first accommodation port 83 in part of the first accommodating portion 81 in the circumferential direction. The cross-sectional shape of the inner surface of the second accommodating portion 82 is, for example, arc-shaped. The transverse cross-sectional shape of the inner surface of the second accommodating portion 82 is formed in a C shape having a second accommodation port 84 in part of the second accommodating portion 82 in the circumferential direction.

As shown in FIG. 12, the first accommodating portion 81 and the second accommodating portion 82 have, for example, the same shape. For example, the first accommodating portion 81 and the second accommodating portion 82 are formed in the same shape as each other when the first wire harness 11A and the second wire harness 12A (see FIG. 11) are not accommodated therein. Note that the transverse cross-sectional shapes of the first accommodating portion 81 and the second accommodating portion 82 are, for example, uniform over the entire length of the first path regulating member 40 in the lengthwise direction. Also, the central axis C1 in the transverse cross-section of the first accommodating portion 81 forms, for example, a straight line, and the central axis C2 in the transverse cross-section of the second accommodating portion 82 forms, for example, a straight line. That is, the first accommodating portion 81 and the second accommodating portion 82 have shapes extending linearly in one direction.

### Configuration of Partition Portion 70

As shown in FIG. 11, the partition portion 70 includes a base end portion connected to the covering portion 43, a leading end portion provided on the side opposite to the base end portion in the Y-axis direction, and an intermediate portion 73 provided between the base end portion and the leading end portion.

The base end portion of the partition portion 70 has, for example, a first skirt portion 71 and a second skirt portion 72 extending in a direction different from that of the first skirt portion 71. The first skirt portion 71 has one end connected to the covering portion 43 and another end connected to the intermediate portion 73 of the partition portion 70. The second skirt portion 72 has one end connected to the covering portion 43 and another end connected to the intermediate portion 73 of the partition portion 70. The first skirt portion 71 and the second skirt portion 72 extend in opposite directions in the alignment direction X from the intermediate portion 73 of the partition portion 70 toward the covering portion 43. That is, the base end portion of the partition portion 70 is formed so as to branch off from the intermediate portion 73 into the first skirt portion 71 and the second skirt portion 72.

The first skirt portion 71 constitutes the first accommodating portion 81. The first skirt portion 71 is formed, for example, in a shape that curves in the form of an arc along the outer peripheral surface of the first exterior member 22 in a view in the lengthwise direction of the first path regulating member 40. The transverse cross-sectional shape of the first skirt portion 71 is, for example, an arc shape extending on the same circumference as the arm portion 44a. The second skirt portion 72 constitutes the second accommodating portion 82. The second skirt portion 72 is formed, for example, in a shape curved in the form of an arc along the outer peripheral surface of the second exterior member 32 in a view in the lengthwise direction of the first path regulating member 40. The cross-sectional shape of the second skirt portion 72 is, for example, an arc shape extending on the same circumference as the arm portion 44b. The first skirt portion 71 and the second skirt portion 72 are formed, for example, in curved shapes that are curved in the form of arcs that protrude toward opposite sides in a view in the lengthwise direction of the first path regulating member 40.

One end of the first skirt portion 71 and one end of the second skirt portion 72 are coupled by a covering portion 43 extending in the alignment direction X, for example. In the first path regulating member 40, for example, a space S1 defined by the first skirt portion 71, the second skirt portion 72, and the covering portion 43 is provided. The space S1 is formed, for example, in a trapezoidal or triangular shape in a view in the lengthwise direction of the first path regulating member 40. The space S1 extends over the entire length of the first path regulating member 40, for example.

The intermediate portion 73 is formed, for example, such that the first skirt portion 71 and the second skirt portion 72 are integrated into one. The intermediate portion 73 is provided in common to both the first accommodating portion 81 and the second accommodating portion 82, for example. That is, the intermediate portion 73 constitutes the first accommodating portion 81 and the second accommodating portion 82. The intermediate portion 73 has a first inner surface 73A forming the inner surface of the first accommodating portion 81 and a second inner surface 73B forming the inner surface of the second accommodating portion 82. The first inner surface 73A and the second inner surface 73B are both end surfaces of the intermediate portion 73 in the alignment direction X.

The transverse cross-sectional shape of the first inner surface 73A is, for example, formed in a shape that is curved in the form of an arc along the outer peripheral surface of the first exterior member 22. The transverse cross-sectional shape of the first inner surface 73A is, for example, formed in an arc shape extending on the same circumference as the inner surface of the arm portion 44a. The transverse cross-sectional shape of the first inner surface 73A is, for example, formed in an arc shape extending on the same circumference as the inner surface of the first skirt portion 71. The transverse cross-sectional shape of the second inner surface 73B is, for example, formed in a shape that is curved in the form of an arc along the outer peripheral surface of the second exterior member 32. The transverse cross-sectional shape of the second inner surface 73B is, for example, an arc shape extending on the same circumference as the inner surface of the arm portion 44b. The transverse cross-sectional shape of the second inner surface 73B is, for example, formed in an arc shape extending on the same circumference as the inner surface of the second skirt portion 72.

The leading end portion of the partition portion 70 is provided at a position opposite to the covering portion 43, with the center of the first exterior member 22 and the center of the second exterior member 32 interposed therebetween in the Y-axis direction. For example, in the Y-axis direction, the shortest distance between the leading end portion of the partition portion 70 and the covering portion 43 is shorter than the shortest distance between the first end portion 45 of the arm portion 44a and the covering portion 43. That is, in the Y-axis direction, the length of the partition portion 70 is shorter than the length of the arm portion 44a.

The leading end portion of the partition portion 70 has a first leading end portion 75 (first leading end) and a second leading end portion 76 (second leading end) extending in a direction different from that of the first leading end portion 75. The leading end of the partition portion 70 is formed to branch from the intermediate portion 73 into two portions, namely the first leading end portion 75 and second leading end portion 76. The first leading end portion 75 and the second leading end portion 76 extend in opposite directions in the alignment direction X from the intermediate portion 73 toward the direction away from the covering portion 43.

The first leading end portion 75 partially covers the outer peripheral surface of the first exterior member 22. The first leading end portion 75 constitutes the first accommodating portion 81. The transverse cross-sectional shape of the first leading end portion 75 is, for example, curved in the form of an arc along the outer peripheral surface of the first exterior member 22. The transverse cross-sectional shape of the first leading end portion 75 is, for example, an arc shape extending on the same circumference as the arm portion 44a. The second leading end portion 76 partially covers the outer peripheral surface of the second exterior member 32. The second leading end portion 76 constitutes the second accommodating portion 82. The transverse cross-sectional shape of the second leading end portion 76 is, for example, curved in the form of an arc along the outer peripheral surface of the second exterior member 32. The transverse cross-sectional shape of the second leading end portion 76 is, for example, an arc shape extending on the same circumference as the arm portion 44b. The first leading end portion 75 and the second leading end portion 76 are formed, for example, in curved shapes that curved in the form of arcs that protrude toward opposite sides in a view in the lengthwise direction of the first path regulating member 40.

The length of the first leading end portion 75, that is, the amount of protrusion of the first leading end portion 75 from the intermediate portion 73 is, for example, equal to the length of the second leading end portion 76, that is, the amount of protrusion of the second leading end portion 76 from the intermediate portion 73. Note that in this specification, the term “equal” includes not only being exactly equal but also a case where there is a slight difference between comparison targets due to dimensional tolerances and the like.

In the first path regulating member 40, each of the leading end 75a of the first leading end portion 75 in the circumferential direction and the leading end 76a of the second leading end portion 76 in the circumferential direction is curved in a view in the lengthwise direction of the first path regulating member 40. In other words, the transverse cross-sectional shapes of the leading end 75a of the first leading end portion 75 and the leading end 76a of the second leading end portion 76 are curved shapes. The transverse cross-sectional shapes of the leading ends 75a and 76a of this embodiment are formed in semicircular shapes.

The first leading end portion 75 and the first end portion 45 are provided on opposite sides in the circumferential direction of the first accommodating portion 81. The first leading end portion 75 and the first end portion 45 are provided spaced apart from each other with the first accommodation port 83 interposed therebetween in the circumferential direction of the first accommodating portion 81. In other words, the gap between the first leading end portion 75 and the first end portion 45 in the circumferential direction of the first accommodating portion 81 is formed as the first accommodation port 83. For example, the first accommodation port 83 is formed by the leading end 75a of the first leading end portion 75 and the leading end 45a of the first end portion 45. The opening width of the first accommodation port 83, that is, the shortest distance between the first leading end portion 75 and the first end portion 45, is smaller than the outer diameter of the first exterior member 22. The opening width of the first accommodation port 83 is smaller than the outer diameter of the first exterior member 22 and smaller than the outer diameter of the second exterior member 32, for example. The first exterior member 22 is inserted into the first accommodation port 83 along a direction perpendicular to the lengthwise direction of the first path regulating member 40.

The second leading end portion 76 and the second end portion 46 are provided on opposite sides to each other in the circumferential direction of the second accommodating portion 82. The second leading end portion 76 and the second end portion 46 are provided apart from each other with the second accommodation port 84 interposed therebetween in the circumferential direction of the second accommodating portion 82. In other words, the gap between the second leading end portion 76 and the second end portion 46 in the circumferential direction of the second accommodation portion 82 is formed as the second accommodation port 84. For example, the second accommodation port 84 is formed by the leading end 76a of the second leading end portion 76 and the leading end 46a of the second end portion 46. The opening width of the second accommodation port 84, that is, the shortest distance between the second leading end portion 76 and the second end portion 46, is smaller than the outer diameter of the second exterior member 32. The opening width of the second accommodation port 84 is smaller than the outer diameter of the first exterior member 22 and smaller than the outer diameter of the second exterior member 32, for example. The opening width of the second accommodation port 84 is equal to the opening width of the first accommodation port 83, for example. The second exterior member 32 is inserted into the second accommodation port 84 along a direction perpendicular to the lengthwise direction of the first path regulating member 40.

In the transverse cross section of the first path regulating member 40, the tangent to the first end portion 45 passing through the central axis C1 of the first accommodating portion 81 is a tangent T3, and the tangent to the first leading end portion 75 passing through the central axis line C1 is a tangent T4. Also, in the transverse cross section of the first path regulating member 40, the tangent to the second end portion 46 passing through the central axis C2 of the second accommodating portion 82 is a tangent T5, and the tangent to the second leading end portion 76 passing through the central axis line C2 is a tangent T6. The opening angle θ1 of the first accommodation port 83 in the circumferential direction of the first accommodating portion 81 is, for example, within the range of 60° to 120°. The opening angle θ2 of the second accommodation port 84 in the circumferential direction of the second accommodating portion 82 is, for example, within the range of 60° to 120°. In the present embodiment, the opening angle θ1 and the opening angle θ2 are equal to each other when the first exterior member 22 and the second exterior member 32 are not accommodated in the first accommodating portion 81 and the second accommodating portion 82, respectively. Note that the opening angle θ1 of the first accommodation port 83 is the angle centered about the central axis C1 of the first accommodating portion 81, that is, the angle formed by the tangents T3 and T4. Also, the opening angle θ2 of the second accommodation port 84 is the angle centered about the central axis C2 of the second accommodating portion 82, that is, the angle formed by the tangents T5 and T6.

The partition portion 70 has a first protrusion portion 77 (first protrusion) protruding from the inner surface of the first leading end portion 75 and a second protrusion portion 78 (second protrusion) protruding from the inner surface of the second leading end portion 76. The first protrusion portion 77 protrudes from the inner surface of the leading end 75a of the first leading end portion 75. The first protrusion portion 77 protrudes toward the first exterior member 22 accommodated inside the first accommodating portion 81. The first protrusion portion 77 is in contact with the outer surface of the first exterior member 22, for example. The second protrusion portion 78 protrudes from the inner surface of the leading end 76a of the second leading end portion 76. The second protrusion portion 78 protrudes toward the second exterior member 32 accommodated inside the second accommodating portion 82. The second protrusion portion 78 is in contact with the outer surface of the second exterior member 32, for example.

The transverse cross-sectional shape of each of the first protrusion portion 77 and the second protrusion portion 78 is, for example, curved. The transverse cross-sectional shape of each of the first protrusion portion 77 and the second protrusion portion 78 is, for example, semicircular. The surface of the first protrusion portion 77 is, for example, formed in an arc shape that is smoothly continuous with the surface of the leading end 75a of the first leading end portion 75 in a view in the lengthwise direction of the first path regulating member 40. In other words, in a view in the lengthwise direction of the first path regulating member 40, the surface of the leading end 75a of the first leading end portion 75 and the surface of the first protrusion portion 77 have arc-shaped surfaces extending on the same circumference. The surface of the second protrusion portion 78 is, for example, formed in an arc shape that is smoothly continuous with the surface of the leading end 76a of the second leading end portion 76 in a view in the lengthwise direction of the first path regulating member 40. In other words, in a view in the lengthwise direction of the first path regulating member 40, the leading end 76a of the second leading end portion 76 and the surface of the second protrusion portion 78 have arc-shaped surfaces extending on the same circumference. The arc-shaped surface formed by the leading end 75a of the first leading end portion 75 and the first protrusion portion 77 and the arc-shaped surface formed by the leading end 76a of the second leading end portion 76 and the second protrusion portion 78 are formed so as to expand on mutually different circumferences. The outer diameter of the arc-shaped surface formed by the leading end 75a of the first leading end portion 75 and the first protrusion portion 77 is, for example, equal to the arc-shaped surface formed by the leading end 76a of the second leading end portion 76 and the second protrusion portion 78.

As shown in FIG. 12, each of the first protrusion portion 77 and the second protrusion portion 78 extends along the lengthwise direction of the first path regulating member 40, for example. Each of the first protrusion portion 77 and the second protrusion portion 78 extends over the entire length of the first path regulating member 40, for example.

As shown in FIG. 11, the first protrusion portion 77 and the first protruding portion 47 press the first exterior member 22 from the outside of the first exterior member 22, for example. The first exterior member 22 is elastically sandwiched between the first protrusion portion 77, the first protruding portion 47, and the covering portion 43, inside the first accommodating portion 81. The second protrusion portion 78 and the second protruding portion 48 press the second exterior member 32 from the outside of the second exterior member 32, for example. The second exterior member 32 is elastically sandwiched between the second protrusion portion 78, the second protruding portion 48, and the covering portion 43, inside the second accommodating portion 82. As a result, the coupling of the first path regulating member 40 to the first exterior member 22 and the second exterior member 32 is strengthened. Accordingly, the movement of the first path regulating member 40 attached to the outer peripheries of the first exterior member 22 and the second exterior member 32 in the lengthwise direction of the first exterior member 22 and the second exterior member 32 is suppressed.

Note that when the first exterior member 22 is inserted into the first accommodating portion 81, the opening width of the first accommodation port 83 does not necessarily return to the original width, that is, the width when the first exterior member 22 is not inserted (see FIG. 12). Specifically, the elastic deformation by which the first accommodating portion 81 attempts to return to its original shape is hindered by the first exterior member 22, whereby the opening width of the first accommodation port 83 becomes wider than the original width in some cases. Also, when the first exterior member 22 is inserted into the first accommodating portion 81, the first exterior member 22 bends due to pressing by the first accommodating portion 81, whereby the opening width of the first accommodation port 83 returns to its original width in some cases. That is, the opening width of the first accommodation port 83 when the first exterior member 22 is inserted into the first accommodating portion 81 is based on the rigidity and ease of bending of the first exterior member 22 and the first accommodating portion 81. Similarly, the opening width of the second accommodation port 84 when the second exterior member 32 is inserted into the second accommodating portion 82 is based on the rigidity and ease of bending of the second exterior member 32 and the second accommodating portion 82.

In the present embodiment, when the first exterior member 22 is inserted into the first accommodating portion 81 and the second exterior member 32 is inserted into the second accommodating portion 82, the opening width of the first accommodation port 83 and the opening width of the second accommodation port 84 are different from each other. Also, when the first exterior member 22 and the second exterior member 32 are accommodated in the first accommodating portion 81 and the second accommodating portion 82, respectively, the opening angle θ1 of the first accommodation port 83 and the opening angle θ2 of the second accommodation port 84 are different from each other. Specifically, the opening angle θ1 of the first accommodation port 83 is larger than the opening angle θ2 of the second accommodation port 84. This is because the outer diameter of the first exterior member 22 is larger than the outer diameter of the second exterior member 32, for example.

The first path regulating member 40 is configured, for example, to snap-fit to the first wire harness 11A and the second wire harness 12A individually. For example, the first wire harness 11A and the second wire harness 12A can be attached to or removed from the first path regulating member 40 at different timings. For example, the first path regulating member 40 can first hold only the first wire harness 11A and thereafter can hold the second wire harness 12A.

Effects of the fifth embodiment will be described.

(21) In the first path regulating member 40, the partition portion 70 divides the portion where the first exterior member 22 is arranged and the portion where the second exterior member 32 is arranged. For this reason, workability when attaching the first exterior member 22 and the second exterior member 32 to the first path regulating member 40 can be improved.

(22) The leading end portion of the partition portion 70 includes a first leading end portion 75 covering part of the outer periphery of the first exterior member 22 and a second leading end portion 76 that extends in a direction different from the first leading end portion 75 and covers part of the outer periphery of the second exterior member 32. That is, the leading end portion of the partition portion 70 is bifurcated into the first leading end portion 75 and the second leading end portion 76. As a result, for example, the length of the first leading end portion 75 and the length of the second leading end portion 76 can be set individually. That is, the amount by which the first leading end portion 75 protrudes from the intermediate portion 73 and the amount by which the second leading end portion 76 protrudes from the intermediate portion 73 can be set individually. For this reason, the range of the outer periphery of the first exterior member 22 covered by the first leading end portion 75 and the range of the outer periphery of the second exterior member 32 covered by the second leading end portion 76 can be set individually. In other words, the opening width of the first accommodation port 83 and the opening width of the second accommodation port 84 can be set individually. As a result, for example, the opening width of the first accommodation port 83 and the opening width of the second accommodation port 84 can be set individually such that the first exterior member 22 and the second exterior member 32 are less likely to deviate from the first accommodating portion 81 and the second accommodating portion 82, respectively.

Furthermore, the opening angle θ1 of the first accommodation port 83 and the opening angle θ2 of the second accommodation port 84 can be set individually. As a result, for example, the insertion angle when inserting the first exterior member 22 into the first accommodating portion 81 and the insertion angle when inserting the second exterior member 32 into the second accommodating portion 82 can be set individually.

(23) The partition portion 70 includes a first protrusion portion 77 that protrudes from the inner surface of the first leading end portion 75 toward the first exterior member 22. As a result, the first protrusion portion 77 can prevent the first exterior member 22 from deviating from the first path regulating member 40. Also, the partition portion 70 has a second protrusion portion 78 that protrudes from the inner surface of the second leading end portion 76 toward the second exterior member 32. As a result, the second protrusion portion 78 can prevent the second exterior member 32 from deviating from the first path regulating member 40.

(24) The first exterior member 22 has a larger outer shape than the second exterior member 32. The first path regulating member 40 collectively holds the first exterior member 22 and the second exterior member 32 having different outer sizes, and regulates the paths of the first wire harness 11A and the second wire harness 12A. That is, even if the sizes of the outer shapes of the first exterior member 22 and the second exterior member 32 are different from each other, the paths of a plurality of wire harnesses can be regulated by one first path regulating member 40. This can contribute to a reduction in the number of components of the composite wire harness 10C.

(25) The first wire harness 11A has two first electric wires 21 forming a direct-current circuit. Also, the second wire harness 12A has three second electric wires 31 forming a three-phase circuit. The path between the first wire harness 11A and the second wire harness 12A is regulated by one first path regulating member 40. As a result, the paths of the first wire harness 11A and the second wire harness 12A used in a four-wheel drive (4WD) vehicle V, for example, can be regulated by one first path regulating member 40. Accordingly, it is possible to contribute to a reduction in the number of components of the composite wire harness 10C.

In the conventional configuration, for example, if the drive system of the vehicle V is front-wheel drive or rear-wheel drive 2WD, a wire harness having only the first wire harness 11A out of the first wire harness 11A and the second wire harness 12A is employed. In addition, in the conventional configuration, if the driving system of the vehicle V is four-wheel drive (4WD), a wire harness with a structure in which the two first electric wires 21 and the three second electric wires 31 are collectively accommodated inside one exterior member is employed. For example, a metal pipe is used as the exterior member. Thus, in the conventional configuration, the wire harness for 2WD and the wire harness for 4WD have completely different structures. For this reason, wire harnesses for 2WD and wire harnesses for 4WD are manufactured through completely different manufacturing methods. In contrast to this, in the configuration of the present embodiment, a wire harness for 4WD can be formed by combining the second wire harness 12A having three second electric wires 31 with the wire harness for 2WD, that is, the first wire harness 11A. For this reason, depending on whether or not the second wire harness 12A is combined with the first wire harness 11A, both a wire harness for 2WD and a wire harness for 4WD can be formed. In other words, the first wire harness 11A can be used in common as a wire harness for 2WD and a wire harness for 4WD (that is, the composite wire harness 10C). Accordingly, the first wire harness 11A can be manufactured through a common manufacturing method in the wire harness for 2WD and the wire harness for 4WD.

Note than when combining the second wire harness 12A with the first wire harness 11A, the first wire harness 11A and the second wire harness 12A can be preferably arranged side by side by using the first path regulating member 40.

Each of the above embodiments can be implemented with the following modifications. Each of the above-described embodiments and the following modified examples can be implemented in combination with each other as long as there is no technical discrepancy.

### Modified Examples of Third Embodiment

In the above-described third embodiment, the second path regulating member 50 was longer than the first path regulating member 40 in the lengthwise direction of the first wire harness 11, but there is no limitation to this, and the first path regulating member 40 may also be longer than the second path regulating member 50. According to this configuration, favorable path regulation can be realized by providing the second path regulating member 50 at a location where stronger path regulation is needed in the first wire harness 11, while the first path regulating member 40 regulates the paths of the first wire harness 11 and the second wire harness 12 over a wide range.

In the above-described third embodiment, the first insertion port 42 of the first path regulating member 40 and the second insertion port 52 of the second path regulating member 50 are open in the same direction along the Y axis. Alternatively, for example, the first insertion port 42 and the second insertion port 52 may face opposite directions.

In the above-described third embodiment, the first end portion 45 of the first main body portion 41 extends farther than the third end portion 53 of the second main body portion 51 in the circumferential direction of the first exterior member 22. However, there is no limitation to this, and the third end portion 53 may also extend beyond the first end portion 45 in the circumferential direction of the first exterior member 22.

In the above-described third embodiment, the second path regulating member 50 may also be attached not only to the first exterior member 22 but also to the outer periphery of the second exterior member 32. The second path regulating member 50 attached to the outer periphery of the second exterior member 32 is arranged inside the first path regulating member 40. According to this configuration, it is possible to regulate the path of the second wire harness 12 more favorably. Also, it is possible to contribute to improving the durability of the second exterior member 32.

The second path regulating member 50 may also be provided with a protrusion that protrudes from the inner surface of the second main body portion 51 and comes into contact with the outer surface of the first exterior member 22. According to such a configuration, it is possible to bring both the third protrusion portion 55 and the protrusion into contact with the outer surface of the first exterior member 22, and as a result, it is possible to suppress rattling of the second path regulating member 50.

In the second path regulating member 50, a groove that extends along the lengthwise direction may also be provided on the outer peripheral surface of the second main body portion 51. According to this configuration, the second main body portion 51 is more easily deformed toward the outer periphery with the groove as a starting point, whereby the second insertion port 52 can be easily widened. As a result, it is possible to contribute to improving the ease of assembly of the second path regulating member 50.

In the second path regulating member 50, the shape of the second main body portion 51 is not limited to an arc shape, and can be changed to an elliptical arc shape, for example. In the above-described third embodiment, the second path regulating member 50 was made of a synthetic resin material. However, there is no limitation to this, and the second path regulating member 50 may also be made of, for example, a metal material.

In the above-described third embodiment, the second path regulating member 50 was harder than the first exterior member 22. However, there is no limitation to this, and the second path regulating member 50 may also have the same hardness as the first exterior member 22 or be softer than the first exterior member 22.

### Modified Examples of Fourth Embodiment

In the above-described fourth embodiment, the third path regulating member 60 was made of a metal material. Alternatively, for example, the third path regulating member 60 may also be made of a colored synthetic resin material. According to this configuration, the third path regulating member 60 can be given a desired color without coating its surface. As a result, by making the color of the third path regulating member 60 a color that enables the worker to recognize that the composite wire harness 10B includes the first electric wire 21 as a high-voltage electric wire, is possible to prompt the worker to be careful not to cut the first electric wire 21 by mistake. Also, by making the third path regulating member 60 the same color as the first path regulating member 40, it is possible to cause the worker to recognize that the composite wire harness 10B includes high-voltage wires. Note that as the material of the third path regulating member 60, for example, a synthetic resin such as polypropylene, polyamide, or polyacetal can be used. The third path regulating member 60 can be molded through a known method such as extrusion molding or injection molding.

Note that even if the third path regulating member 60 is made of a synthetic resin material, it is desirable that the third path regulating member 60 is harder than the first exterior member 22 and the second exterior member 32. However, the constituent material of the third path regulating member 60 does not need to be harder than the constituent material of the first exterior member 22 and the constituent material of the second exterior member 32. That is, the constituent material of the third path regulating member 60 may be harder or softer than the constituent material of the first exterior member 22 and the constituent material of the second exterior member 32. Also, the constituent material of the third path regulating member 60 may be the same material as the constituent material of the first exterior member 22 and the constituent material of the second exterior member 32.

In the fourth embodiment, the third path regulating member 60 was shorter than the first path regulating member 40 in the lengthwise direction of the first path regulating member 40. However, there is no limitation to this, and the third path regulating member 60 may also be longer than the first path regulating member 40.

In the fourth embodiment, the first insertion port 42 of the first path regulating member 40 and the third insertion port 62 of the third path regulating member 60 are open in the same direction along the Y axis. Alternatively, for example, the first insertion port 42 and the third insertion port 62 may also face opposite directions.

In the above-described fourth embodiment, the fifth end portion 65 extends farther than the first end portion 45 of the first main body portion 41 in the circumferential direction of the first exterior member 22. However, there is no limitation to this, and the first end portion 45 may also extend farther than the fifth end portion 65 in the circumferential direction of the first exterior member 22. Also, the second end portion 46 may extend farther than the sixth end portion 66 in the circumferential direction of the second exterior member 32. That is, the opening width of the third insertion port 62 in the alignment direction X may also be wider than the opening width of the first insertion port 42 in the alignment direction X.

In the third path regulating member 60, the outer peripheral surface of the third main body portion 61 may also be provided with a groove extending along the lengthwise direction. According to this configuration, the third main body portion 61 is more easily deformed toward the outer periphery with the groove as a starting point, whereby the third insertion port 62 can be easily widened. As a result, it is possible to contribute to an improvement in the ease of assembly of the third path regulating member 60.

In the fourth embodiment, the third path regulating member 60 was harder than the first exterior member 22 and the second exterior member 32. However, there is no limitation to this, and the third path regulating member 60 may also have a hardness equal to that of the first exterior member 22 and the second exterior member 32, or may be softer than the first exterior member 22 and the second exterior member 32.

### Modified Example of Fifth Embodiment

The structure of the first path regulating member 40 of the fifth embodiment can be changed as appropriate.

For example, as shown in FIG. 13, a portion of the covering portion 43 that couples one end of the first skirt portion 71 and one end of the second skirt portion 72 may also be omitted. In this case, the first path regulating member 40 is formed, for example, in a structure in which a C-shaped first accommodating portion 81 and a C-shaped second accommodating portion 82 are coupled by an intermediate portion 73 of the partition portion 70. Also, in the first path regulating member 40 of this modified example, the space S1 between the first skirt portion 71 and the second skirt portion 72 is open in a direction away from the intermediate portion 73 in the Y-axis direction. For this reason, if a member other than the first path regulating member 40 is provided in the vicinity of the first path regulating member 40, for example, it is possible to favorably prevent the other member and the first path regulating member 40 from interfering with each other by letting the other member escape into the space S1.

In the first path regulating member 40 of the fifth embodiment, the first accommodating portion 81 and the second accommodating portion 82 may also be formed in different shapes. For example, when the first exterior member 22 and the second exterior member 32 are not inserted, the transverse cross-sectional shape of the first accommodating portion 81 and the transverse cross-sectional shape of the second accommodating portion 82 may also be formed in different shapes.

In the partition portion 70 of the above-described fifth embodiment, the length of the first leading end portion 75 and the length of the second leading end portion 76 may be set to different lengths. That is, the amount by which the first leading end portion 75 protrudes from the intermediate portion 73 and the amount by which the second leading end portion 76 protrudes from the intermediate portion 73 may be set to different amounts.

In the partition portion 70 of the above-described fifth embodiment, the outer diameter of the arc-shaped surface formed by the leading end 75a of the first leading end portion 75 and the first protrusion portion 77 and the outer diameter of the arc-shaped surface constituted by the leading end 76a of the second leading end portion 76 and the second protrusion portion 78 may be set to different sizes.

In the partition portion 70 of the above-described fifth embodiment, the first leading end portion 75 and the second leading end portion 76 may also be formed in different shapes. For example, the transverse cross-sectional shape of the first leading end portion 75 and the transverse cross-sectional shape of the second leading end portion 76 may also be formed in mutually different shapes.

The first protrusion portion 77 of the above-described fifth embodiment may also be provided at a position spaced farther apart from the first accommodation port 83 relative to the leading end 75a of the first leading end portion 75 in the circumferential direction of the first accommodating portion 81. Also, the second protrusion portion 78 may be provided at a position spaced farther apart from the second accommodation port 84 relative to the leading end 76a of the second leading end portion 76 in the circumferential direction of the second accommodation portion 82.

In the partition portion 70 of the above-described fifth embodiment, the base end portion of the partition portion 70 had a structure divided into the first skirt portion 71 and the second skirt portion 72, but there is no limitation to this. For example, the base end portion of the partition portion 70 may also be changed to a structure that does not branch into two, that is, a structure that is integrated into one like the intermediate portion 73. For example, the intermediate portion 73 may also be modified so as to extend to the covering portion 43.

In the partitioning portion 70 of the above-described fifth embodiment, the transverse cross-sectional shape of the first inner surface 73A and the second inner surface 73B of the intermediate portion 73 is not limited to an arc shape, and can be changed to a shape that extends in a linear shape along the Y-axis direction, for example.

In the above-described second embodiment, the first protrusion portion 49a and the second protrusion portion 49b may also be partially provided in the lengthwise direction of the first path regulating member 40. Also, in the above-described fifth embodiment, the first protrusion portion 77 and the second protrusion portion 78 may be partially provided in the lengthwise direction of the first path regulating member 40.

At least one of the first protrusion portion 49a and the second protrusion portion 49b may also be omitted in the above-described second embodiment. Also, in the fifth embodiment, at least one of the first protrusion portion 77 and the second protrusion portion 78 may also be omitted.

In the above-described first embodiment and the above-described fourth embodiment, the recesses and protrusions of the outer peripheral surface of the first exterior member 22 mesh with the recesses and protrusions of the outer peripheral surface of the second exterior member 32 at the portion held by the first path regulating member 40. However, there is no limitation to this, and the outer peripheral surface of the first exterior member 22 and the outer peripheral surface of the second exterior member 32 may simply be in contact with each other in a state in which the recesses and protrusions do not mesh with each other.

In the above-described second embodiment and the above-described fifth embodiment, the third path regulating member 60 may also be provided outside of the first path regulating member 40.

In the above-described first to third embodiments and the above-described fifth embodiment, the first path regulating member 40 was made of a synthetic resin material. Alternatively, for example, the first path regulating member 40 may also be made of a metal material. According to this configuration, it is possible to effectively block heat transmitted from the outside to the first exterior member 22 and the second exterior member 32 by the first path regulating member 40 made of a metal material. Note that in the third embodiment, if the first path regulating member 40 is made of metal, the second path regulating member 50 made of a synthetic resin can prevent the first path regulating member 40 made of metal from coming into contact with the first exterior member 22. As a result, it is possible to suppress wear of the first exterior member 22 caused by contact with the first path regulating member 40 made of metal.

In each of the above-described embodiments, the first path regulating member 40 was made harder than the first exterior member 22 and the second exterior member 32.

However, there is no limitation to this, and the first path regulating member 40 may also have a hardness equal to that of the first exterior member 22 and the second exterior member 32, or may be softer than the first exterior member 22 and the second exterior member 32.

In each of the above-described embodiments, the first protruding portion 47 and the second protruding portion 48 may be partially provided in the lengthwise direction of the first path regulating member 40. Also, in the above-described third embodiment, the third protruding portion 55 may be partially provided in the lengthwise direction of the second path regulating member 50. Also, in the above-described fourth embodiment, the fourth protruding portion 67 may also be partially provided in the lengthwise direction of the third path regulating member 60.

The first protruding portion 47 and the second protruding portion 48 of each of the above-described embodiments may also be provided at positions spaced farther apart from the first insertion port 42 than the leading end 45a of the first end portion 45 and the leading end 46a of the second end portion 46 in the circumferential direction of the first path regulating member 40. Also, each third protruding portion 55 of the above-described third embodiment may also be provided at a position spaced farther apart from the second insertion port 52 than the leading end 53a of the third end portion 53 and the leading end 54a of the fourth end portion 54 in the circumferential direction of the second path regulating member 50. Also, each of the fourth protruding portions 67 of the fourth embodiment may also be provided at a position spaced farther apart from the third insertion port 62 than the leading end 65a of the fifth end portion 65 and the leading end 66a of the sixth end portion 66 in the circumferential direction of the third path regulating member 60.

At least one of the first protruding portion 47 and the second protruding portion 48 may also be omitted in each of the above-described embodiments. Also, in the above-described third embodiment, at least one of the third protruding portion 55 of the third end portion 53 and the third protruding portion 55 of the fourth end portion 54 may also be omitted. Also, in the above-described fourth embodiment, at least one of the fourth protruding portion 67 of the fifth end portion 65 and the fourth protruding portion 67 of the sixth end portion 66 may also be omitted.

In the first path regulating member 40 of each of the above-described embodiments, the outer peripheral surface of the first main body portion 41 may also be provided with a groove extending along the lengthwise direction. According to this configuration, the first main body portion 41 can be easily deformed toward the outer peripheral side with the groove as a starting point, whereby the first insertion port 42 can be easily widened. As a result, it is possible to contribute to an improvement in the ease of assembly of the first path regulating member 40.

In the above-described first to fourth embodiments, the first wire harness 11 may also be changed to a first wire harness 11A, and the second wire harness 12 may also be changed to a second wire harness 12A.

In each of the above-described embodiments, the first electric wire 21 was a high-voltage electric wire and the second electric wire 31 was a low-voltage electric wire. However, there is no limitation to this, and for example, each of the first electric wire 21 and the second electric wire 31 may be a high voltage electric wire or a low-voltage electric wire.

The disclosed embodiments and modified examples are illustrative in all regards and not to be construed as limiting. The scope of the present disclosure is defined by the claims and not by the above description, and all changes that fall within the meaning and range of equivalency of the claims are intended to be embraced therein.

As shown in FIG. 3, the opening width of the first insertion port 42 of the first path regulating member 40 may also be larger than the outer diameter of the first exterior member 22 and larger than the outer diameter of the second exterior member 32. Similarly, in other examples as well, the opening width of the first insertion port 42 of the first path regulating member 40 may also be larger than the outer diameter of one exterior member.

As in the example shown in FIG. 3, the first path regulating member 40 may also be configured to snap-fit to the bundle of the first wire harness 11 and the second wire harness 12. For example, in the example shown in FIG. 3, the first wire harness 11 and the second wire harness 12 can be attached to or removed from the first path regulating member 40 at the same timing. The examples of FIGS. 7 and 9 may also be the same as that of FIG. 3.

As in the example shown in FIG. 5, the first path regulating member 40 may also be configured to snap-fit to the first wire harness 11 and the second wire harness 12 individually. For example, the first wire harness 11 and the second wire harness 12 can be attached to or removed from the first path regulating member 40 at different timings. For example, in the example of FIG. 5, the first path regulating member 40 may first hold only the first wire harness 11 and then hold the second wire harness 12.

As shown in FIG. 3, in a view in the lengthwise direction of the first path regulating member 40, the surface of the leading end 45a of the first end portion 45 may have an arc shape that is smoothly continuous with the surface of the first protruding portion 47. In other words, a view in the lengthwise direction of the first path regulating member 40, the leading end 45a of the first end portion 45 and the first protruding portion 47 may have arc-shaped surfaces that extend on the same circumference. Similarly, the surface of the leading end 46a of the second end 46 may have arc shapes that are smoothly continuous with the surface of the second protruding portion 48. In other words, in a view in the lengthwise direction of the first path regulating member 40, the leading end 46a of the second end portion 46 and the second protruding portion 48 may have arc-shaped surfaces extending on the same circumference. Note that the first end 45 may be referred to as the first edge, and the second end portion 46 may be referred to as the second edge.

As shown in FIGS. 2 and 3, the first insertion port 42 may be a first groove extending in the lengthwise direction of the first path regulating member 40 and extending linearly over the entire length of the first path regulating member 40, and the first groove may be open at both ends of the first path regulating member 40 in the lengthwise direction. The first path regulating member 40 may be referred to as a first path defining member that defines the paths of the first wire harness 11 and the second wire harness 12.

As shown in FIG. 3, the covering portion 43 of the first path regulating member 40 may be in the form of a flat plate parallel to the lengthwise direction and the alignment direction X of the first path regulating member 40. The arm portions 44a and 44b may have plate shapes that curve in the form of arcs that protrude in opposite directions in a view in the lengthwise direction of the first path regulating member 40. The arm portion 44a may extend around the center of the first exterior member 22 over a range greater than 90°. As a result, in the circumferential direction of the first exterior member 22, the arm portion 44a may extend from a position corresponding to one end of the covering portion 43 in the alignment direction X to a position on the side opposite to the covering portion 43 with the center of the first exterior member 22 interposed therebetween. Similarly, the arm portion 44b may extend around the center of second exterior member 32 over a range greater than 90°. As a result, in the circumferential direction of the second exterior member 32, the arm portion 44b may extend from a position corresponding to one end of the covering portion 43 in the alignment direction X to a position on the side opposite to the covering portion 43 with the center of the second exterior member 32 interposed therebetween.

As shown in FIG. 5, the leading end portion of the partition portion 49 may be located on the side opposite to the covering portion 43 with the center of the first exterior member 22 and the center of the second exterior member 32 interposed therebetween in the Y-axis direction. The shortest distance between the leading end portion of the partition portion 49 and the first end portion 45 and the shortest distance between the leading end portion of the partition portion 49 and the second end portion 46 may be equal to each other. The base end portion of the partition portion 49 includes a first skirt portion curved in an arc shape along the outer peripheral surface of the first exterior member 22 and a second skirt portion curved in an arc shape along the outer peripheral surface of the second exterior member 32 in a view in the lengthwise direction of the first path regulating member 40. The first path regulating member 40 may also have a substantially trapezoidal or substantially triangular space defined by the first skirt portion, the second skirt portion, and the covering portion 43.

As shown in FIG. 5, in a view in the lengthwise direction of the first path regulating member 40, the surface of the first protrusion portion 49a may have an arc shape that is smoothly continuous with the surface of the second protrusion portion 49b. In other words, in a view in the lengthwise direction of the first path regulating member 40, the first protrusion portion 49a and the second protrusion portion 49b may have arc-shaped surfaces extending on the same circumference. The outer diameter of the arc-shaped surfaces formed by the first protrusion portion 49a and the second protrusion portion 49b may also be equal to the outer diameter of the arc-shaped surfaces formed by the leading end 45a of the first end portion 45 and the first protrusion portion 47, and the outer diameter of the arc-shaped surfaces formed by the leading end 46a of the second end portion 46 and the second protruding portion 48.

As shown in FIG. 7, in a view in the lengthwise direction of the second path regulating member 50, the surface of the leading end 53a of the third end portion 53 has an arc shape that is smoothly continuous with the surface of the third protruding portion 55 of the third end portion 53. In other words, in a view in the lengthwise direction of the second path regulating member 50, the leading end 53a of the third end portion 53 and the third protruding portion 55 of the third end portion 53 may have arc-shaped surfaces extending on the same circumference. Similarly, the surface of the leading end 54a of the fourth end portion 54 may have an arc shape that is smoothly continuous with the surface of the third protruding portion 55 of the fourth end portion 54. In other words, in a view in the lengthwise direction of the second path regulating member 50, the leading end 54a of the fourth end portion 54 and the third protruding portion 55 of the fourth end portion 54 may have arc-shaped surfaces extending on the same circumference. Note that the third end portion 53 is referred to as a third edge, and the fourth end portion 54 is referred to as a fourth edge in some cases.

The outer diameter of the arc-shaped surfaces formed by the leading end 53a of the third end portion 53 and the third protruding portion 55 of the third end portion 53, and the outer diameter of the arc-shaped surfaces formed by the leading end 54a of the fourth end portion 54 and the third protruding portion 55 of the fourth end portion 54 may be equal to the outer diameter of the arc-shaped surface formed by the leading end 45a of the first end portion 45 and the first protruding portion 47 and the outer diameter of the arc-shaped surface formed by the leading end 46a of the second end portion 46 and the second protruding portion 48.

As shown in FIGS. 6 and 7, the second insertion port 52 may be a second groove extending along the lengthwise direction of the second path regulating member 50 and extending linearly over the entire length of the second path regulating member 50, and the second groove may be open at both ends of the second path regulating member 50 in the lengthwise direction. The second path regulating member 50 is referred to as a second path defining member that defines the path of the first wire harness 11, in some cases.

As shown in FIG. 9, in a view in the lengthwise direction of the third path regulating member 60, the surface of the leading end 65a of the fifth end portion 65 may have an arc shape that is smoothly continuous with the surface of the fourth protruding portion 67 of the fifth end portion 65. In other words, in a view in the lengthwise direction of the third path regulating member 60, the leading end 65a of the fifth end portion 65 and the fourth protruding portion 67 of the fifth end portion 65 may have arc-shaped surfaces extending on the same circumference. Similarly, the surface of the leading end 66a of the sixth end portion 66 may have an arc shape that is smoothly continuous with the surface of the fourth protruding portion 67 of the sixth end portion 66. In other words, in a view in the lengthwise direction of the third path regulating member 60, the leading end 66a of the sixth end portion 66 and the fourth protruding portion 67 of the sixth end portion 66 may have arc-shaped surfaces extending on the same circumference. Note that the fifth end portion 65 is referred to as a fifth edge, and the sixth end portion 66 is referred to as a sixth edge in some cases.

The outer diameter of the arc-shaped surfaces formed by the leading end 65a of the fifth end portion 65 and the fourth protruding portion 67 of the fifth end portion 65, and the outer diameter of the arc-shaped surfaces formed by the leading end 66a of the sixth end portion 66 and the fourth protruding portion 67 of the sixth end portion 66 may be equal to the outer diameter of the arc-shaped surfaces formed by the leading end 45a of the first end portion 45 and the first protruding portion 47, and the outer diameter of the arc-shaped surfaces formed by the leading end 46a of the second end portion 46 and the second protruding portion 48.

As shown in FIGS. 8 and 9, the third insertion port 62 may be a third groove extending along the lengthwise direction of the third path regulating member 60 and extending linearly over the entire length of the third path regulating member 60, and the third groove may be open at both ends of the third path regulating member 60 in the lengthwise direction. The third path regulating member 60 is referred to as a third path defining member that defines the paths of the first wire harness 11 and the second wire harness 12, in some cases.

As shown in FIG. 9, the covering portion 63 of the third path regulating member 60 may be in the form of a flat plate parallel to the lengthwise direction and the alignment direction X of the third path regulating member 60. The arm portions 64a and 64b may be plate shapes that are curved in the form of arcs that protrude in opposite directions in a view in the lengthwise direction of the third path regulating member 60. The arm portion 64a may extend around the center of the first exterior member 22 over a range greater than 90°. As a result, in the circumferential direction of the first exterior member 22, the arm portion 64a may extend from a position corresponding to one end of the covering portion 63 in the alignment direction X to a position on the side opposite to the covering portion 63 with the center of the first exterior member 22 interposed therebetween. Similarly, the arm portion 64b may extend around the center of second exterior member 32 over a range greater than 90°. As a result, in the circumferential direction of the second exterior member 32, the arm portion 64b may extend from a position corresponding to one end of the covering portion 63 in the alignment direction X to a position on the side opposite to the covering portion 43 with the center of the second exterior member 32 interposed therebetween.

As shown in FIG. 7, substantially half of the outer peripheral surface of the second main body portion 51 on the side of the arm portion 44a may be in areal contact with the inner peripheral surface of the arm portion 44a. As shown in FIG. 9, the outer peripheral surface of the first path regulating member 40 may be in areal contact with the inner peripheral surface of the third path regulating member 60. Specifically, the outer peripheral surface of the arm portion 44a may be in areal contact with the inner peripheral surface of the arm portion 64a, the outer peripheral surface of the arm portion 44b may be in areal contact with the inner peripheral surface of the arm portion 64b, and the inner surface of the covering portion 63 may be in areal contact with the outer surface of the covering portion 43.

As shown in FIGS. 10 to 12, the first accommodation port 83 may be a fourth groove extending along the lengthwise direction of the first path regulating member 40 and extending linearly over the entire length of the first path regulating member 40, and the fourth groove may be open at both ends of the first path regulating member 40 in the lengthwise direction. The second accommodation port 84 may be a fifth groove extending linearly along the lengthwise direction of the first path regulating member 40 and over the entire length of the first path regulating member 40, and the fifth groove may be open at both ends of the first path regulating member 40 in the lengthwise direction. The first path regulating member 40 shown in FIGS. 10 to 12 is referred to as a first path defining member that defines the paths of the first wire harness 11A and the second wire harness 12A, in some cases.

This disclosure encompasses the following examples. Reference signs of some constituent elements of the exemplary embodiments have been added to facilitate understanding and not for limitation. Some of the items described in the examples below may be omitted, and some of the items described in the examples may be selected or extracted and combined with each other.

Supplementary Note 1

In one aspect of the present disclosure, the base end portion of the partition portion (49) may have a first skirt portion that is curved in the form of an arc along an outer peripheral surface of the first exterior member (22) and a second skirt portion that is curved in the form of an arc along an outer peripheral surface of the second exterior member (32), in a view in the lengthwise direction of the first path regulating member (40).

Supplementary Note 2

In one aspect of the present disclosure, the first main body portion (41) may have a covering portion (43) and a pair of arm portions (44a, 44b), and half of the outer peripheral surface of the second main body portion (51) toward one of the pair of arm portions (44a, 44b) may be in areal contact with the inner peripheral surface of the one arm portion (44a).

Supplementary Note 3

In one aspect of the present disclosure, the outer peripheral surface of the first path regulating member (40) may be in areal contact with the inner peripheral surface of the third path regulating member (60).

Supplementary Note 4

In one aspect of the present disclosure, the first protruding portion (47) may protrude from the inner surface of the leading end (45a) of the first end portion (45),

the second protruding portion (48) may protrude from the inner surface of the leading end (46a) of the second end portion (46),

in a view in the lengthwise direction of the first path regulating member (40),

the surface of the leading end (45a) of the first end portion (45) may have an arc shape that is smoothly continuous with the surface of the first protruding portion (47), and

the surface of the leading end (46a) of the second end portion (46) may have an arc shape that is smoothly continuous with the surface of the second protruding portion (48).

Supplementary Note 5

In one aspect of the present disclosure, the partition portion (49) may include a first protrusion portion (49a) that protrudes from the leading end portion of the partition portion (49) toward the first exterior member (22) and a second protrusion portion (49b) that protrudes from the leading end portion of the partition portion (49) toward the second exterior member (32), and

the surface of the first protrusion portion (49a) may have an arc shape that is smoothly continuous with the surface of the second protrusion portion (49b).

Supplementary Note 6

In one aspect of the present disclosure, the third protruding portion (55) may protrude from the inner surface of each of the leading end of the third end portion (53) and the leading end of the fourth end portion (54),

in a view in the lengthwise direction of the second path regulating member (50),

the surface of the leading end (53a) of the third end portion (53) may have an arc shape that is smoothly continuous with the surface of the third protruding portion (55) of the third end portion (53), and

the surface of the leading end (54a) of the fourth end portion (54) may have an arc shape that is smoothly continuous with the surface of the third protruding portion (55) of the fourth end portion (54).

Supplementary Note 7

In one aspect of the present disclosure, the fourth protruding portion (67) may protrude from the inner surface of each of the leading end of the fifth end portion (65) and the leading end of the sixth end portion (56),

in a view in the lengthwise direction of the third path regulating member (60),

the surface of the leading end (65a) of the fifth end portion (65) may have an arc shape that is smoothly continuous with the surface of the fourth protruding portion (67) of the fifth end portion (65), and

the surface of the leading end (66a) of the sixth end portion (66) may have an arc shape that is smoothly continuous with the surface of the fourth protruding portion (67) of the sixth end portion (66).

1. A composite wire harness, comprising:
a first wire harness including a first electric wire and a first exterior tube covering the first electric wire;
a second wire harness including a second electric wire and a second exterior tube covering the second electric wire; and
a first path regulator configured to be attached to the first wire harness and the second wire harness, wherein:
the first wire harness is arranged side by side with the second wire harness,
the first path regulator includes a first main body that partially covers an outer periphery of the first exterior tube and the second exterior tube, and a first insertion port formed by a first end and a second end that are both ends in a circumferential direction of the first main body,
the first insertion port is an opening extending in a lengthwise direction of the first path regulator and extends over an entire length of the first path regulator, and
the first path regulator collectively holds the first wire harness and the second wire harness.

2. The composite wire harness according to claim 1, wherein the first path regulator is harder than the first exterior tube and the second exterior tube.

3. The composite wire harness according to claim 1, wherein the first path regulator includes a first protrusion that protrudes from an inner surface of the first end and comes into contact with an outer surface of the first exterior tube, and a second protrusion that protrudes from an inner surface of the second end and comes into contact with an outer surface of the second exterior tube.

4. The composite wire harness according to claim 1, wherein:
the first path regulator has a partition that protrudes from the first main body toward the first insertion port, and
the partition is located between the first exterior tube and the second exterior tube.

5. The composite wire harness according to claim 4, wherein a leading end of the partition includes a first leading end that partially covers the outer periphery of the first exterior tube and a second leading end that extends in a direction different from that of the first leading end and partially covers the outer periphery of the second exterior tube.

6. The composite wire harness according to claim 5, wherein the portion includes a first protrusion that protrudes from an inner surface of the first leading end toward the first exterior tube, and a second protrusion that protrudes from an inner surface of the second leading end toward the second exterior tube.

7. The composite wire harness according to claim 1, further comprising
a second path regulator configured to be attached to the outer periphery of the first exterior tube, wherein:
the second path regulator includes a second main body that partially covers the outer periphery of the first exterior tube, and a second insertion port formed by a third end and a fourth end that are both ends in a circumferential direction of the second main body,
the second insertion port is an opening extending in a lengthwise direction of the second path regulator and extends over an entire length of the second path regulator, and
the second path regulator is arranged between an outer peripheral surface of the first exterior tube and the first path regulator.

8. The composite wire harness according to claim 7, wherein the second path regulator is harder than the first exterior tube.

9. The composite wire harness according to claim 7, wherein the second path regulator is longer than the first path regulator in a lengthwise direction of the first wire harness.

10. The composite wire harness according to claim 7, wherein the second path regulator includes a third protrusion that protrudes from an inner surface of at least one of the third end and the fourth end and comes into contact with the outer surface of the first exterior tube.

11. The composite wire harness according to claim 1, further comprising
a third path regulator configured to be attached to the first path regulator, wherein:
the third path regulator includes a third main body covering an outer periphery of the first path regulator, and a third insertion port formed by a fifth end and a sixth end that are both ends in the circumferential direction of the third main body, and
the third insertion port is an opening extending in a lengthwise direction of the third path regulator and extends over an entire length of the third path regulator.

12. The composite wire harness according to claim 11, wherein the third path regulator is harder than the first exterior tube and the second exterior tube.

13. The composite wire harness according to claim 11, wherein the third path regulator is shorter than the first path regulator in the lengthwise direction of the first path regulator.

14. The composite wire harness according to claim 11, wherein the third path regulator is made of a metal material.

15. The composite wire harness according to claim 14, wherein the first path regulator is made of a synthetic resin material.

16. The composite wire harness according to claim 11, wherein the third path regulator is made of a colored synthetic resin material.

17. The composite wire harness according to claim 16, wherein:
the first path regulator is made of a colored synthetic resin material, and
the third path regulator is made of a synthetic resin material that is a same color as the first path regulator.

18. The composite wire harness according to claim 7, wherein the second path regulator is made of a colored synthetic resin material.

19. The composite wire harness according to claim 18, wherein:
the first path regulator is made of a colored synthetic resin material, and
the second path regulator is made of a synthetic resin material that is a same color as the first path regulator.

20. The composite wire harness according to claim 1, wherein the first path regulator is made of a colored synthetic resin material.

21. The composite wire harness according to claim 1, wherein the first path regulator is made of a metal material.

22. The composite wire harness according to claim 1, wherein the first exterior tube has a larger outer shape than the second exterior tube.

23. The composite wire harness according to claim 1, wherein:
the first electric wire of the first wire harness is two first electric wires,
the second electric wire of the second wire harness is three second electric wires,
the two first electric wires are electric wires that form a direct-current circuit, and
the three second electric wires are electric wires that form a three-phase circuit.
